(19) United States
(12) Patent Application Publication
(10) Pub. No.: US 2026/0213697 A1
(43) Pub. Date: Jul. 23, 2026

(54) MOUNTING SYSTEM FOR A METAL PANEL

(71) Applicant: RMH TECH LLC, Colorado Springs, CO (US)

(72) Inventors: Jonathon Moss, Grandview, TX (US); Dustin M.M. Haddock, Bonifay, FL (US); Samuel D. Bontje, Colorado Springs, CO (US)

(73) Assignee: RMH TECH LLC, Colorado Springs, CO (US)

(21) Appl. No.: 19/451,969

(22) Filed: Jan. 16, 2026

Related U.S. Application Data
(60) Provisional application No. 63/746,789, filed on Jan. 17, 2025.

(51) Int. Cl. H02S 20/23; F16B 7/18

(52) U.S. Cl. CPC H02S 20/23; F16B 7/18

(57) ABSTRACT

A mounting system for installing photovoltaic modules on a metal panel includes a mounting device operable to couple to a panel projection of the metal panel. A mounting assembly including a mount is coupled to the mounting device via a first fastener. A grab is installed on the mount of the mounting assembly and coupled to the mounting assembly with a second fastener. Engagement of components within a first interlocking assembly holds the grab in a first configuration relative to the mount, unless a force is applied to cause the grab to transition to a second configuration where the components of the interlocking assembly are disengaged. The mounting assembly can include a riser between the mount and the mounting device, where the first fastener couples the mount and the riser to the mounting device, and where the mount and the riser are coupled via a second interlocking assembly.

### CROSS-REFERENCE TO RELATED APPLICATION

The present application claims the benefit of priority under 35 U.S.C. § 119(e) to U.S. Provisional Ser. No. 63/746,789, filed on Jan. 17, 2025, the entirety of which is incorporated herein by reference.

### FIELD

The disclosure relates to a mounting system configured to be secured to a projection extending from a metal panel defining a roof or a sidewall of a building.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Metal panels are frequently used to construct parts of buildings such as roofs and sidewalls. During construction, adjacent panels are connected at joints, which are weatherproof and protect the building from the external environment. One type of joint is a standing seam joint that extends or protrudes away from the main surfaces of the panels. The standing seam mechanically joins two adjacent metal panels. These seamed joints may have many different configurations, including a single fold, double fold, snap seam, snap lock, nail strip, batten cap, T-seam, and bulb seam. Some roof joints, including bulb seams, may be slidably connected to an underlying halter or clip, such that the roof joint “floats” on the underlying halter or clip. Some metal panels have ribs (e.g., that are trapezoidal) that extend from the panel. The ribs are positioned between seams that join the metal panel to adjacent metal panels.

It is often desirable to install various types of structures such as heating units, air conditioning units, ventilation equipment, snow retention systems (or snow fences), solar panels, and the like on metal panels, particularly metal panels used to form a roof. These structures can be secured to the metal panel with fasteners. However, installing structures on the roof in a manner that punctures the metal panel or which requires the formation of a hole through the metal panel is undesirable. Puncturing the metal panel or a roof joint with a fastener that forms or requires a hole presents leakage and corrosion issues for the roof, and holes in the metal panel are aesthetically displeasing. Further, forming holes through a metal panel may void a warranty provided by the manufacturer.

Mounting devices can provide a location for these structures to mount to a roof. Typically, a mounting device is secured to a fold, a joint, or a seam between two metal panels or to a rib extending from a metal panel (collectively referred to herein as “a panel projection”) without puncturing the metal panel. A structure may then be connected to the mounting device. Mounting devices can be secured to the roof by squeezing or clamping to the panel projection that extends away from the roof.

### SUMMARY

Aspects of the present disclosure are directed to a mounting system including a mounting device (or mounting bracket), a mounting assembly, and a grab (or clip, or clamp). The mounting device is able to engage a panel projection on a roof. A photovoltaic (PV) module is insertable into a space defined between opposing surfaces of the grab and the mounting assembly.

In aspects of the present disclosure, the mounting assembly includes a separate mount and a riser. In another aspect of the present disclosure, the separate mount and riser of the mounting assembly are combined into an integrated mount of the mounting system. Optionally, grounding inserts may be installed on the mount for engagement with a photovoltaic solar panel (e.g., for engagement with the frame). In addition, arms of the grab optionally includes grounding surfaces.

In aspects of the present disclosure, the mount of the mounting assembly and the grab are usable to install one or two PV modules onto the roof through engagement of the panel projection with the mounting device, and the installation of the mounting assembly and the grab on the mounting device. In some aspects, the mount includes one or two PV platforms that extend from a body. Optionally, a particular PV platform includes a stop to distance an edge of the PV module a pre-determined distance from a body of the mount. In aspects, the grab includes one or two arms, where each arm corresponds to a particular PV platform of the mount.

In aspects of the present disclosure, the mount and/or the grab have mirrored symmetry across a longitudinal axis through the mounting system. Alternatively, the mount and/or the grab may be asymmetric across the longitudinal axis. For example, the asymmetry may be to promote installation of multiple PV modules on the same mounting system, including in a particular order relative to the direction of installation of the mounting system on the roof. By way of another example, the asymmetry may provide a PV platform and an edge guard on the same mounting system.

In aspects of the present disclosure, the grab and the mount are dimensioned such that there is an interference fit between legs of the grab and a body of the mount, to cause the grab to remain positioned on the body of the mount at a pre-determined location absent an external force being applied on the grab. In other aspects of the present disclosure, the legs of the grab are able to freely move along the body of the mount.

In another aspect of the present disclosure, a fastener is insertable through an aperture in the grab and an aperture in the mount. In another aspect of the present disclosure, a fastener is insertable through an aperture in the riser and into (or through) an aperture in the mounting device. It is noted that the same fastener may extend through the apertures in the grab, the mount, and the riser before engaging the aperture in the mounting device.

In aspects of the present disclosure, a mounting system includes a mounting device, a mounting assembly including a mount, and a grab. In some instances, the mount is couplable directly to the mounting device via a first fastener, and the grab is couplable to the mount via a second fastener. The first fastener is inserted into the mount and the mounting device prior to engagement of the grab on the mount and subsequent insertion of the second fastener. The grab may optionally include an aperture for access to the first fastener after engagement of the grab on the mount, including for when adjustment of the first fastener is necessary during installation of the mounting system on the panel projection of the metal panel. The first fastener and the second fastener can have respective longitudinal axes that are offset from one another.

The grab and the mount share an interlocking assembly that, when engaged, locate an arm of the grab a first pre-determined distance from a PV platform of the mount. When the interlocking assembly is disengaged, the arm of the grab transitions to the second pre-determined distance from the PV platform. For example, the second distance is less than the first distance, securing a PV module between the arm and the PV platform. It is noted that the first distance may be maintained via the engaged interlocking assembly unless an external force is applied to the grab, allowing for pre-assembly of the mounting system prior to installation on a panel projection of a metal panel. One or both of the arm and the PV platform include engagement features that make contact with the PV module when secured between the arm and the PV platform.

Optionally, the mounting assembly includes a riser that couples to the mount, such that the riser is positioned between the mount and the mounting device. Here, the first fastener is inserted into the mount and the riser before being inserted into the mounting device, prior to engagement of the grab on the mount, and subsequent insertion of the second fastener.

The mount and the riser may share an interlocking assembly that, when engaged, couple to the riser to the mount. For example, the riser may be rigid enough that the mount must be slid into the riser (e.g., along a direction of extrusion for the riser and/or the mount) to the interlocking assembly shared by the riser and the mount. In other configurations, the riser may have enough pliancy to allow for the mount to snap into the riser when engaging the interlocking assembly.

In aspects of the present disclosure, the mount of a mounting assembly within a mounting system may be of a length that the mount is able to receive and engage with multiple grabs. The mount has one or more apertures to receive fasteners for each respective grab. The mounting system may include one or more mounting devices for a panel projection of a metal panel. For example, the mounting assembly may include a single mounting device of extended length, similar to the mount. By way of another example, the mounting assembly may include a mounting device per respective grab.

Optionally, the mounting assembly includes one or more risers for the mount, where the one or more risers are positioned between the mount and the one or more mounting devices. For example, the mounting assembly may include a single riser of extended length, similar to the mount. By way of another example, the mounting assembly may include a riser per respective grab.

In another aspect of the present disclosure, one or more of the grab, the mount, the riser, the integrated mount and riser, and the mounting device are extruded from a metal including, but not limited to, an aluminum. In another aspect of the present disclosure, the optional grounding inserts may be formed (e.g., stamped, punched, bent, and the like) from sheet metal including, but not limited to, a steel.

In general, aspects of the present disclosure are directed to a mounting system that includes fewer complex and/or restrictive interlocking features of known mounting systems. The mounting system should include components that are economical to produce (i.e., requiring less manufacturing material, cost, and/or time) and which are able to secure to a panel projection quickly and easily by decreasing installation time compared to known systems. The mounting system should also provide increased performance compared to known systems.

A first aspect of the present disclosure is to provide a mounting system for a metal panel. The mounting system includes a mounting device operable to couple to a panel projection of the metal panel, where the mounting device has a first aperture. The mounting system includes a mounting assembly positionable on the mounting device, where the mounting assembly includes a second aperture and a photovoltaic (PV) platform. The mounting system includes a grab positionable on the mounting assembly, where the grab includes a third aperture and an arm. The arm of the grab and the PV platform of the mounting assembly together define a space for a PV module. A fastener is positionable through the first aperture, the second aperture, and the third aperture together to secure the PV module when inserted within the space defined by the arm and the PV platform.

The mounting system of the first aspect may include, optionally, that the mounting assembly includes a riser positionable on the mounting device, the riser including the second aperture. The mounting assembly includes a mount positionable on the riser, the mount including the PV platform and a fourth aperture. The grab is positionable on the mount. The fastener is positionable through the first aperture, the second aperture, the fourth aperture, and the third aperture together to secure the PV module within the space defined by the arm and the PV platform.

The mounting system of the first aspect may include one or more of the previous embodiments and, optionally, that the mounting assembly includes an integrated mount, the integrated mount including the second aperture and the PV platform. The grab is positionable on the integrated mount.

The mounting system of the first aspect may include one or more of the previous embodiments and, optionally, that the mounting assembly includes a second PV platform and the grab including a second arm. The second arm of the grab and the second PV platform of the mounting assembly together define a second space for a second PV module. The fastener is positionable through the first aperture, the second aperture, and the third aperture together to secure the second PV module when inserted within the second space defined by the second arm and the second PV platform.

A second aspect of the present disclosure is to provide a method for installation of a mounting system to a metal panel. The method may include, but is not limited to, coupling a mounting device to a panel projection of a metal panel, the mounting device including a first aperture. The method may include, but is not limited to, positioning a mounting assembly on the mounting device, the mounting assembly including a second aperture and a photovoltaic (PV) platform. The method may include, but is not limited to, positioning a grab on the mounting assembly, where the grab includes a third aperture and an arm. The arm of the grab and the PV platform of the mounting assembly together define a space for a PV module. A fastener is positionable through the first aperture, the second aperture, and the third aperture together to secure the PV module when inserted within the space defined by the arm and the PV platform.

The method of the second aspect may include, optionally, that the positioning the mounting assembly on the mounting device includes positioning a riser on a mounting device, where the riser includes the second aperture. The method of the second aspect may include, optionally, positioning a mount on the riser, the mount including the PV platform and a fourth aperture. The grab is positioned on the mount. The fastener is positionable through the first aperture, the second aperture, the fourth aperture, and the third aperture together to secure the PV module within the space defined by the arm and the PV platform.

The method of the second aspect may include one or more of the previous embodiments and, optionally, that the positioning of the mounting assembly on the mounting device includes positioning an integrated mount on the mounting device, the integrated mount including the second aperture and the PV platform. The grab is positioned on the integrated mount.

The method of the second aspect may include one or more of the previous embodiments and, optionally, that the mounting assembly including a second PV platform and the grab including a second arm. The second arm of the grab and the second PV platform of the mounting assembly together define a second space for a second PV module. A fastener is positionable through the first aperture, the second aperture, and the third aperture together to secure the second PV module when inserted within the second space defined by the second arm and the second PV platform.

A third aspect of the present disclosure is to provide a mount to interconnect a photovoltaic module to a mounting device securable to a panel projection projecting from a building surface. The mount includes a top surface. The mount includes a first sidewall extending away from the top surface. The mount includes a second sidewall extending away from the top surface, where interior surfaces of the first and second sidewalls are approximately parallel. The mount includes an aperture extending through the top surface between the first and second sidewalls, the aperture configured to receive a shaft of a fastener to interconnect the mount to the mounting device. The mount includes a first PV platform extending from a first side of the mount. The first PV platform includes a first upper surface adapted to selectively support the photovoltaic module.

The mount of the third aspect may include, optionally, that the aperture is unthreaded.

The mount of the third aspect may include one or more of the previous embodiments and, optionally, that the first upper surface of the first PV platform is generally planar.

The mount of the third aspect may include one or more of the previous embodiments and, optionally, that the first PV platform includes a first groove recessed downwardly in a vertical dimension relative to the first upper surface, the first groove extending in a lateral dimension.

The mount of the third aspect may include one or more of the previous embodiments and, optionally, further includes a grounding insert configured to fit at least partially into the first groove such that an upward surface of the grounding insert is approximately co-planar with the first upper surface of the first PV platform when the grounding insert is engaged to the first PV platform.

The mount of the third aspect may include one or more of the previous embodiments and, optionally, where the grounding insert includes a first hook to engage a first end of the first PV platform, and a second hook to engage a second end of the first PV platform.

The mount of the third aspect may include one or more of the previous embodiments and, optionally, that the grounding insert further includes a dimple extending from the upward surface such that the dimple projects above the first upper surface of the first PV platform when the grounding insert is engaged to the first PV platform.

The mount of the third aspect may include one or more of the previous embodiments and, optionally, that the first PV platform further includes a first edge stop extending from the first upper surface in a vertical dimension.

The mount of the third aspect may include one or more of the previous embodiments and, optionally, that the first edge stop is positioned between an end of the first PV platform and the first sidewall.

The mount of the third aspect may include one or more of the previous embodiments and, optionally, that the first edge stop is configured to space a frame of the photovoltaic module a predetermined distance from a central reference plane extending in the vertical dimension and the lateral dimension and through the aperture.

The mount of the third aspect may include one or more of the previous embodiments and, optionally, further includes a second PV platform extending from a second side of the mount. The second PV platform includes a second upper surface adapted to selectively support a second photovoltaic module.

The mount of the third aspect may include one or more of the previous embodiments and, optionally, that the second upper surface of the second PV platform is generally planar.

The mount of the third aspect may include one or more of the previous embodiments and, optionally, that the second upper surface is approximately co-planar with the first upper surface of the first PV platform.

The mount of the third aspect may include one or more of the previous embodiments and, optionally, that the second PV platform further includes a second edge stop extending from the second upper surface in the vertical dimension.

The mount of the third aspect may include one or more of the previous embodiments and, optionally, that the first PV platform extends a first distance in the longitudinal dimension, and the second PV platform extends a second distance in the longitudinal dimension, the second distance being less than the first distance.

The mount of the third aspect may include one or more of the previous embodiments and, optionally, that the mount is of a one-piece construction and is formed from a single piece of the metal material.

A fourth aspect of the present disclosure is to provide a mounting system for coupling a photovoltaic (PV) module to a metal panel of a building. The mounting system includes a mounting device operable to couple to a panel projection of the metal panel. The mounting system includes a mounting assembly positionable on the mounting device, where the mounting assembly includes a PV platform. The mounting system includes a grab positionable on the mounting assembly, where the grab includes a body and an arm. The mounting system includes a first fastener insertable through at least one aperture in the mounting assembly and into an aperture in the mounting device to couple the mounting assembly to the mounting device, where the first fastener is accessible via a first aperture within the body of the grab. The mounting system includes a second fastener insertable through a second aperture within the body of the grab and at least a second aperture in the mounting assembly to couple the grab to the mounting assembly, where a longitudinal axis through the second fastener is offset from a longitudinal axis through the first fastener. The arm of the grab and the PV platform of the mounting assembly together define a space for a PV module. The PV module is securable within the defined space when inserted between the arm and the PV platform.

The mount of the fourth aspect may include, optionally, that the mounting assembly has a mount including a body with an aperture of the at least one aperture of the mounting assembly and a leg extending from the body, where the PV platform extends from the leg. The grab is positionable on the leg of the mount. The first fastener is insertable through the aperture of the body of the mount and into the aperture of the mounting device.

The mount of the fourth aspect may include one or more of the previous embodiments and, optionally, that the grab couples to the mount via at least one interlocking assembly. The grab is positionable in a first configuration and a second configuration on the mount via the at least one interlocking assembly.

The mount of the fourth aspect may include one or more of the previous embodiments and, optionally, that the at least one interlocking assembly includes a recess on the mount and a protrusion on the grab. When the grab is in the first configuration the protrusion is engaged with the recess and the arm of the grab is spaced a first distance from the PV platform of the mount. When the grab is in the second configuration the protrusion is disengaged from the recess and the arm of the grab is spaced a second distance from the PV platform of the mount.

The mount of the fourth aspect may include one or more of the previous embodiments and, optionally, when the grab is in the second configuration the second distance is less than the first distance, and the arm makes contact with the PV module.

The mount of the fourth aspect may include one or more of the previous embodiments and, optionally, that the grab transitions from the first configuration to the second configuration via rotation of the second fastener.

The mount of the fourth aspect may include one or more of the previous embodiments and, optionally, that the mount is positionable on the mounting device.

The mount of the fourth aspect may include one or more of the previous embodiments and, optionally, that the mounting assembly further includes a riser positionable on the mounting device, the riser having a base with a second aperture of the at least one aperture of the mounting assembly and a sidewall extending from the base. The mount couples to the riser via at least one interlocking assembly. The first fastener is insertable through the aperture of the body of the mount, the second aperture of the base of the riser, and the aperture of the mounting device.

The mount of the fourth aspect may include one or more of the previous embodiments and, optionally, that the at least one interlocking assembly includes one or more of a notch and a protrusion of the riser that are configured to receive one or more of a respective protrusion and a respective notch of the mount.

The mount of the fourth aspect may include one or more of the previous embodiments and, optionally, that the mounting system is configured such that the first fastener is insertable into the aperture of the body of the mount and the aperture of the mounting device prior to the grab being coupled to the mount.

The mount of the fourth aspect may include one or more of the previous embodiments and, optionally, that the mount defines a cavity into which at least one protrusion extends. The at least one protrusion supports a third fastener able to engage with the second fastener after insertion of the second fastener through the second aperture of the grab and through an aperture of the body of the mount of the at least a second aperture of the mounting assembly.

The mount of the fourth aspect may include one or more of the previous embodiments and, optionally, that the mounting assembly including a second PV platform and the grab including a second arm. The second arm of the grab and the second PV platform of the mounting assembly together define a second space for a second PV module. The second PV module is securable within the defined space when inserted between the second arm and the second PV platform.

A fifth aspect of the present disclosure is to provide a method for coupling a photovoltaic (PV) module to a metal panel of a building. The method may include, but is not limited to, providing a mounting assembly and coupling the mounting assembly to a mounting device operable to couple to a panel projection of the metal panel. The mounting assembly includes a PV platform. A first fastener is insertable through at least one aperture in the mounting assembly and into an aperture in the mounting device to couple the mounting assembly to the mounting device. The method may include, but is not limited to, positioning a grab on the mounting assembly to form a mounting system. The grab includes a body and an arm. The first fastener is accessible via a first aperture within the body of the grab. A second fastener is insertable through a second aperture within the body of the grab and at least a second aperture in the mounting assembly to couple the grab to the mounting assembly. A longitudinal axis through the second fastener is offset from a longitudinal axis through the first fastener.

The method of the fifth aspect may include, optionally, that the providing a mounting assembly and coupling the mounting assembly includes providing a mount including a body with an aperture of the at least one aperture of the mounting assembly and a leg extending from the body. The PV platform extends from the leg. The grab is positionable on the mount. The first fastener is insertable through the aperture of the body of the mount and into the aperture of the mounting device.

The method of the fifth aspect may include one or more of the previous embodiments and, optionally, that the grab couples to the mount via at least one interlocking assembly. The grab is positionable in a first configuration and a second configuration on the mount via the at least one interlocking assembly.

The method of the fifth aspect may include one or more of the previous embodiments and, optionally, that the grab couples to the mount via at least one interlocking assembly. The grab is positionable in a first configuration and a second configuration on the mount via the at least one interlocking assembly.

The method of the fifth aspect may include one or more of the previous embodiments and, optionally, that the at least one interlocking assembly includes a recess on the mount and a protrusion on the grab. When the grab is in the first configuration the protrusion is engaged with the recess and the arm of the grab is spaced a first distance from the PV platform of the mount. When the grab is in the second configuration the protrusion is disengaged from the recess and the arm of the grab is spaced a second distance from the PV platform of the mount.

The method of the fifth aspect may include one or more of the previous embodiments and, optionally, that the providing a mounting assembly and coupling the mounting assembly includes providing a riser including a base with a second aperture of the at least one aperture of the mounting assembly and a sidewall extending from the base. The mount couples to the riser via at least one interlocking assembly. The first fastener is insertable through the aperture of the body of the mount, the second aperture of the base of the riser, and the aperture of the mounting device.

The method of the fifth aspect may include one or more of the previous embodiments and, optionally, that the at least one interlocking assembly includes one or more a notch and a protrusion of the riser that are configured to receive one or more of a respective protrusion and a respective notch of the mount.

The method of the fifth aspect may include one or more of the previous embodiments and, optionally, may include, but is not limited to, coupling the mounting system to a panel projection of a metal panel. The method of the fifth aspect may include, but is not limited to, installing a PV module in the mounting system, where the PV module is supported by the PV platform of the mounting assembly. The method of the fifth aspect may include, but is not limited to, engaging the PV module with the arm of the grab by rotating the second fastener.

A sixth aspect of the present disclosure is to provide a mounting system for coupling a photovoltaic (PV) module to a metal panel of a building. The mounting system includes a mounting device operable to couple to a panel projection of the metal panel. The mounting system includes a mounting assembly positionable on the mounting device, where the mounting assembly includes a PV platform that extends from a mount including a groove. The mounting system includes a first grab positionable on the mount, where the first grab includes a first body and a first arm. The first grab couples to the mount via at least a first interlocking assembly including a first protrusion on a first leg extending from the first body which is able to engage with the groove of the mounting assembly. The first grab is positionable in a first configuration and a second configuration on the mount via the at least a first interlocking assembly. The mounting system includes a first fastener insertable through an aperture in the first grab and a first aperture in the mount to couple the first grab to the mount. The mounting system includes a second grab positionable on the mount, where the second grab includes a second body and a second arm. The second grab couples to the mount via at least a second interlocking assembly including a second protrusion on a second leg extending from the second body which is able to engage with the groove of the mounting assembly. The second grab is positionable in a third configuration and a fourth configuration on the mount via the at least a second interlocking assembly. The mounting system includes a second fastener insertable through an aperture in the second grab and a second aperture in the mount to couple the second grab to the mount. The first arm of the first grab and the PV platform of the mounting assembly together define a first space for a first PV module. The first PV module is securable within the defined first space when inserted between the first arm and the PV platform. The second arm of the second grab and the PV platform of the mounting assembly together define a second space for a second PV module. The second PV module is securable within the defined second space when inserted between the second arm and the PV platform.

Example PV module mounting systems are described in U.S. Pat. Nos. 7,758,011, 8,430,372, 8,627,617, 9,920,958, 10,054,336, 10,502,457, 10,903,785, 11,616,468, 12,231,081, 12,519,418, U.S. Patent Application Publication No. 2014/0096462, and U.S. Patent Application Publication No. 2025/0080036, which are each incorporated herein by reference in their entirety.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

Unless otherwise indicated, all numbers expressing quantities, dimensions, conditions, and so forth used in the specification and claims are to be understood as being modified in all instances by the term “about.”

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “about equal” or “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio

can be any value of at least 4.5 and no more than 5.5, the second number in the ratio can be any value of at least 2.7 and no more than 3.3, and so on.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the disclosure given above and the detailed description of the drawings given below, serve to explain the principles of the disclosure.

FIG. 1A illustrates a first perspective view of a mounting system for a metal panel, the mounting system including a mounting device, a grab, and a mounting assembly including a riser and a mount in accordance with one or more embodiments of the present disclosure;

FIG. 1B illustrates a second perspective view of the mounting system of FIG. 1A;

FIG. 1C illustrates a front elevation view of the mounting system of FIG. 1A;

FIG. 2A illustrates a perspective view of a riser that may optionally be used with the mounting assembly of FIG. 1A;

FIG. 2B illustrates a front elevation view of the riser of FIG. 2A;

FIG. 2C illustrates a front-top perspective view of the riser of FIG. 2A;

FIG. 3A illustrates a first perspective view of a mount of the mounting assembly of FIG. 1A;

FIG. 3B illustrates a second perspective view of the mount of FIG. 3A;

FIG. 3C illustrates a front elevation view of the mount of FIG. 3A;

FIG. 3D illustrates a front-top perspective view of the mount of FIG. 3A;

FIG. 4 illustrates a perspective view of a grounding insert of the mounting assembly of FIG. 1A;

FIG. 5A illustrates a first perspective view of the grab and the mount of the mounting system of FIG. 1A;

FIG. 5B illustrates a second perspective view of the grab and the mount of FIG. 5A;

FIG. 5C illustrates a front elevation view of the grab and the mount of FIG. 5A;

FIG. 5D illustrates a front-top perspective view of the grab and the mount of FIG. 5A;

FIG. 6A illustrates a first perspective view of a variation of the grab with a variation of the mount of the mounting system of FIG. 1A;

FIG. 6B illustrates a second perspective view of the grab and the mount of FIG. 6A;

FIG. 6C illustrates a front elevation view of the grab and the mount of FIG. 6A;

FIG. 6D illustrates a front-top perspective view of the grab and the mount of FIG. 6A;

FIG. 7A illustrates a first perspective view of an integrated mount that may optionally be used with the mounting system of FIG. 1A;

FIG. 7B illustrates a second perspective view of the integrated mount of FIG. 7A;

FIG. 7C illustrates a front elevation view of the integrated mount of FIG. 7A;

FIG. 7D illustrates a front-top perspective view of the integrated mount of FIG. 7A;

FIG. 8 illustrates a flow diagram of a method or process for installation of the mounting system of FIG. 1A, in accordance with one or more embodiments of the present disclosure;

FIG. 9A illustrates a perspective view of a mounting system for a metal panel, the mounting system including a mounting device, a grab, and a mounting assembly including a riser and a mount in accordance with one or more embodiments of the present disclosure;

FIG. 9B is a top plan view of the mounting system of FIG. 9A;

FIG. 9C is a front elevation view of the mounting system of FIG. 9A;

FIG. 9D is a rear elevation view of the mounting system of FIG. 9A;

FIG. 10A illustrates a perspective view of the riser of the mounting assembly of FIG. 9A;

FIG. 10B illustrates a front elevation view of the riser of FIG. 10A;

FIG. 10C illustrates a front-top perspective view of the riser of FIG. 10A;

FIG. 11A illustrates a perspective view of the mount that may optionally be used in the mounting assembly of FIG. 9A;

FIG. 11B illustrates a front elevation view of the mount of FIG. 11A;

FIG. 11C illustrates a front-top perspective view of the mount of FIG. 11A;

FIG. 12A illustrates a perspective view of the grab of the mounting assembly of FIG. 9A;

FIG. 12B illustrates a front elevation view of the grab of FIG. 12A;

FIG. 12C illustrates a front-top perspective view of the grab of FIG. 12A;

FIG. 13 illustrates a perspective view of a variation of the mounting system of FIG. 9A for a metal panel, the mounting system including two of a variation of the grab and a variation of the mount of the mounting assembly;

FIG. 14 illustrates a perspective view of a variation of the mounting system of FIG. 9A for the metal panel, the mounting assembly including only the mount; and

FIG. 15 illustrates a flow diagram of a method or process for installation of the mounting system of FIG. 9A, in accordance with one or more embodiments of the present disclosure.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein. It is noted that any line in the drawings may be illustrated as solid or broken lines, including any section or length of each individual line, without departing from the scope of the present disclosure.

| Reference | |
|---|---|
| Number | Component |
| 100, 100A | Mounting System |
| 102 | Mounting Device |
| 104 | Mounting Assembly |
| 106, 106A | Grab |
| 108 | Riser |
| 110, 110A | Mount |
| 112 | Aperture in Sidewall of Mounting Device |
| 114 | Cavity |
| 116 | Sidewall |
| 118 | Sidewall |
| 120 | Recess |
| 122 | Fastener |
| 124 | Aperture of Grab |
| 126 | Aperture of Mounting Device |
| 128 | Aperture of Mount |
| 130 | Aperture of Riser |
| 132 | PV Module |
| 200 | Body |
| 202 | Base |
| 204 | Sidewalls |
| 206 | Distal End |
| 208 | Proximal End |
| 210 | Cavity |
| 212 | Groove |
| 214 | Interlocking Assembly |
| 300 | Body |
| 302 | Base |
| 304 | Sidewalls |
| 306 | Distal End |
| 308 | Proximal End |
| 310 | Cavity |
| 312 | PV Platform |
| 314 | Edge Stop |
| 316 | Groove |
| 318 | PV Platform |
| 320 | Edge Stop |
| 322 | Groove |
| 324 | Protrusions |
| 400 | Grounding Insert |
| 402 | Protrusions |
| 404 | Body |
| 406 | Tabs or Hooks |
| 500 | Body |
| 502 | Legs |
| 504 | Proximal End |
| 506 | Distal End |
| 508 | Cavity |
| 510 | Arm |
| 512 | Engagement Features |
| 514 | Arm |
| 516 | Engagement Features |
| 600 | Edge Platform |
| 602 | Protrusion |
| 604 | Groove |
| 700 | Integrated Mount |
| 702 | Body |
| 704 | First Portion |
| 706 | Second Portion |
| 708 | Surface |
| 800 | Method or Process |
| 802 | Couple Mounting Device to Panel Projection |
| 804 | Position Mounting Assembly on Mounting Device |
| 806 | Position Riser on Mounting Device |
| 808 | Position Mount on Riser |
| 810 | Position Integrated Mount on Mounting Device |
| 812 | Position Grab on Mounting Assembly |
| 814 | Install Fastener in Grab |
| 816 | Install PV Modules on Metal Panel with Mounting |
| | System |
| 818 | Engage PV Modules with Grab |
| 900 | Mounting System |
| 904, 904A | Mounting Assembly |
| 906, 906A | Grab |
| 908 | Riser |
| 910, 910A | Mount |
| 912 | Fastener |
| 914 | Aperture of Mount |
| 916 | Aperture of Riser |
| 917 | Interlocking Assembly of Mount and Grab |
| 918 | Groove |
| 920 | Protrusion |
| 922 | Fastener |
| 924 | Aperture of Grab |
| 926 | Aperture of Mount |
| 928 | Fastener |
| 930 | Cavity |
| 932 | Protrusions |
| 934 | Aperture of Grab |
| 936 | Tool Engagement Feature |
| 937 | Interlocking Assembly |
| 938 | Aperture of Riser |
| 1000 | Body of Riser |
| 1002 | Base |
| 1004 | Sidewalls |
| 1006 | Distal End |
| 1008 | Proximal End |
| 1010 | Cavity |
| 1012 | Notch |
| 1014 | Protrusion |
| 1100 | Body of Mount |
| 1102 | Legs of Mount |
| 1104 | Proximal End |
| 1106 | Distal End |
| 1108 | Exterior Surface |
| 1110 | Protrusion |
| 1112 | Interior Surface |
| 1114 | PV Platform |
| 1116 | Surface |
| 1118 | Concavity |
| 1120 | PV Platform |
| 1122 | Surface |
| 1124 | Concavity |
| 1126 | Protrusion |
| 1128 | Notch |
| 1130 | Receiver for Engagement Features |
| 1200 | Body of Grab |
| 1202 | Legs of Grab |
| 1204 | Proximal End |
| 1206 | Distal End |
| 1208 | Cavity |
| 1210 | Arm |
| 1212 | Engagement Features |
| 1214 | Arm |
| 1216 | Engagement Features |
| 1218 | Receiver for Engagement Features |
| 1500 | Method or Process |
| 1502 | Provide a Mounting Assembly and Couple to Mounting |
| | Device |
| 1504 | Couple Mount to Riser to Form Mounting Assembly |
| 1506 | Insert Fastener Through Mounting Assembly into |
| | Mounting Device |
| 1508 | Position Grabs on Mounting Assembly in Pre- |
| | Installation Configuration to Form Mounting System |
| 1510 | Insert Fastener Through Grabs into Mounting Assembly |
| 1512 | Couple Mounting System to Panel Projection on Metal |
| | Panel |
| 1514 | Install PV Modules on Metal Panel with Mounting |
| | System |
| 1516 | Engage PV Modules with Grabs in Post-Installation |
| | Configurations |

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the mounting system for a metal panel would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the mounting system can be combined with dimensions, aspects, and features of another embodiment of the mounting system to create the claimed embodiment.

In general, embodiments of the present disclosure are directed to a mounting system for a metal panel. The mounting system is less complex and less restrictive in terms of methods of installation, reducing installation time and cost over known mounting systems and methods. The mounting system also includes components that are economical to produce, reducing manufacturing material and time over the known mounting systems and methods. The mounting system includes components that provide increased performance as compared to other known mounting systems and methods.

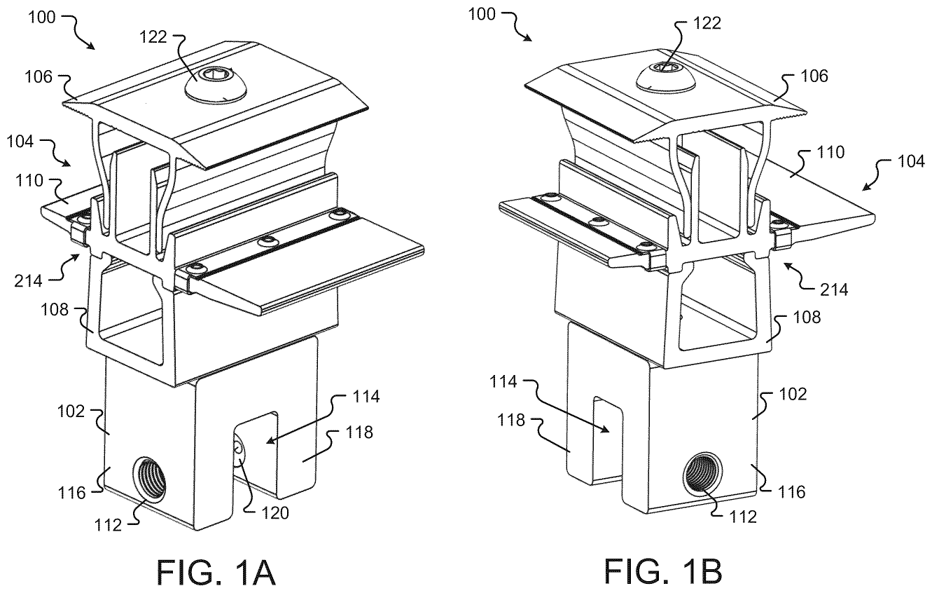

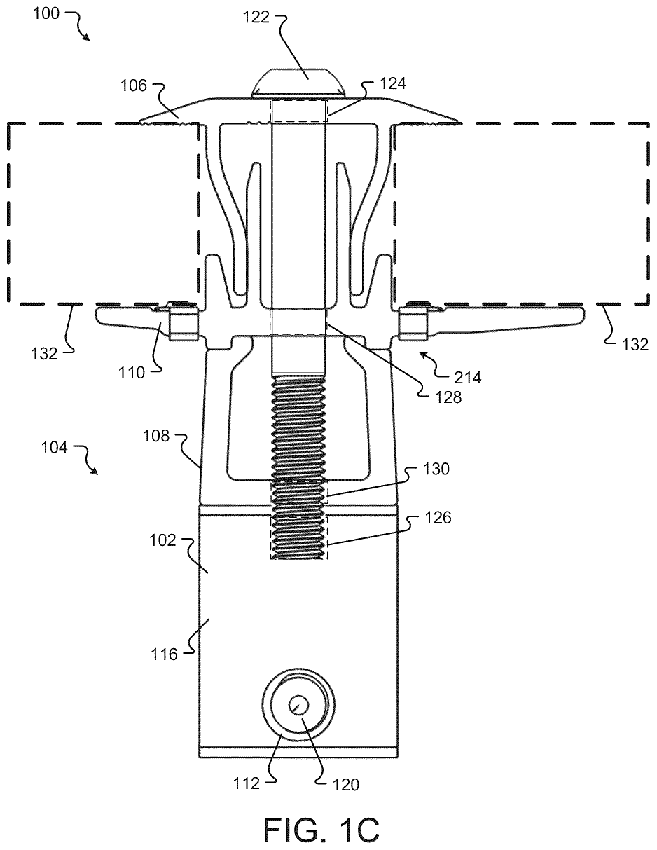

FIGS. 1A-1C illustrate a mounting system 100, in accordance with one or more embodiments of the present disclosure. The mounting system 100 includes a mounting device 102, a mounting assembly 104, and a grab 106.

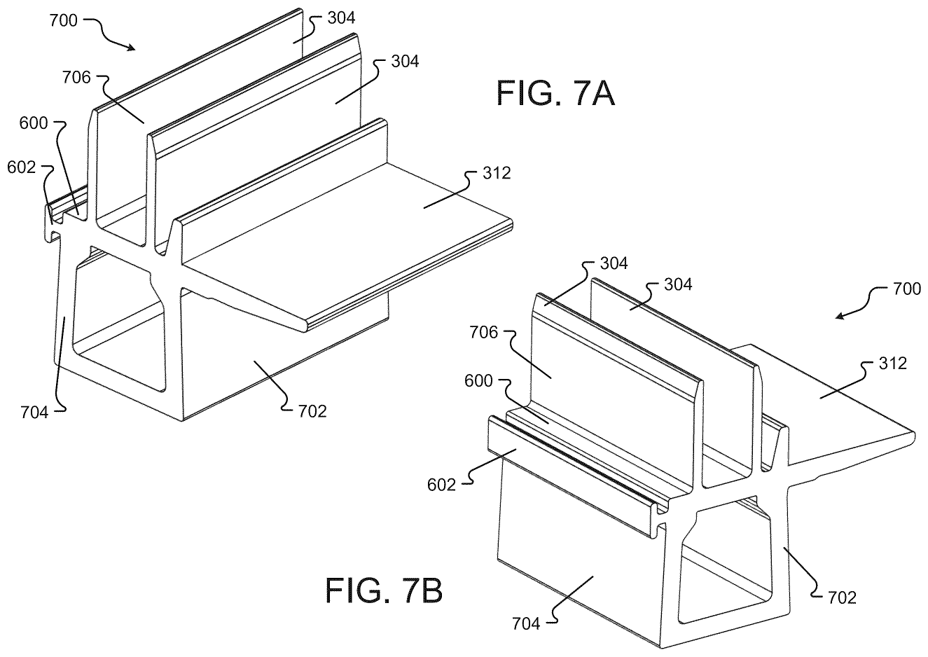

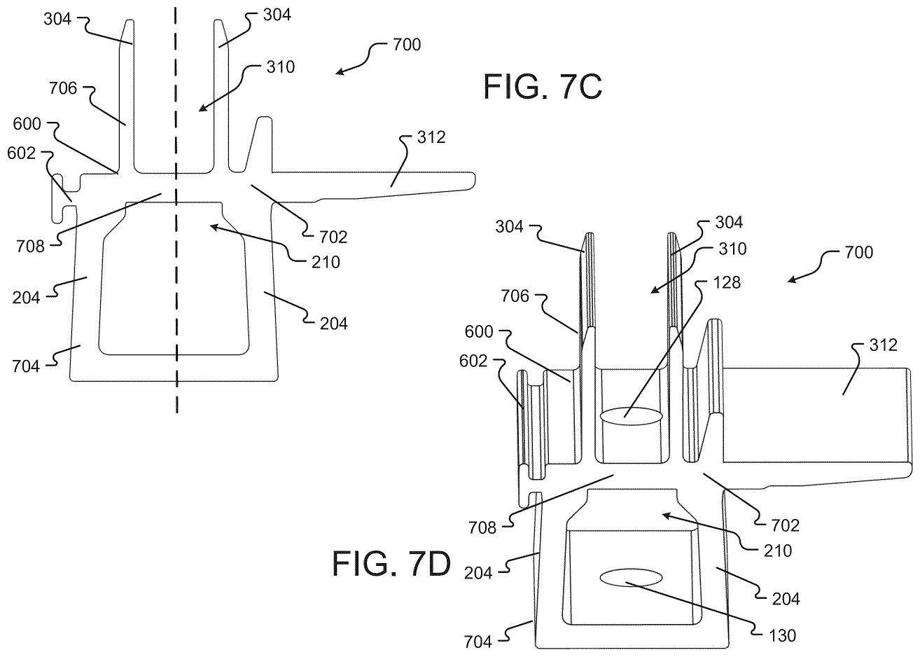

In embodiments, the mounting assembly 104 includes a riser 108 and a mount 110. For example, the riser 108 and the mount 110 are separate components, where the mount 110 is positionable on the riser 108 between the mounting device 102 and the grab 106. In other embodiments, the mounting assembly 104 includes an integrated mount 700 as illustrated in FIGS. 7A-7D, where the integrated mount 700 is positionable on the mounting device 102 and is configured to engage with the grab 106. In some embodiments, the mounting assembly 104 does not include the riser 108 and the mount 110 is positionable directly on the mounting device 102.

In embodiments, the mounting device 102 is couplable to a panel projection of a roof (not shown). The mounting device 102 includes an aperture 112 that leads to a defined cavity 114 within the mounting device 102. For example, the cavity 114 is operable to receive the panel projection of the roof. Optionally, the aperture 112 passes through a first sidewall 116 of the mounting device 102 into the cavity 114.

In addition, a surface of a second sidewall 118 of the mounting device 102 optionally includes a recess 120 opposite the aperture 112, where a longitudinal axis through the aperture 112 is aligned with the recess 120. In some instances, the insertion of the fastener within the aperture 112 of the mounting device 102 is angled (e.g., including, but not limited to, at an oblique angle, or at a substantially perpendicular or orthogonal angle) to a direction of extrusion of the mounting device 102. In some configurations, the recess 120 allows for deformation of the panel projection of the metal panel by the fastener inserted within the aperture 112 when securing the mounting device 102 to the panel projection, to increase the securing force provided by the fastener inserted within the aperture 112 between the mounting device 102 and the panel projection.

In embodiments, a fastener 122 is usable to secure components of the mounting system 100 together post-assembly. For example, the fastener 122 may pass through an aperture 124 in the grab 106, one or more apertures in the mounting assembly 104, and engage with an aperture 126 in the mounting device 102. For instance, the mounting assembly 104 may include an aperture 128 in the mount 110 and an aperture 130 in the riser 108 that receives the fastener 122 after being inserted through the aperture 124 of the grab 106 and prior to being inserted into the aperture 126 of the mounting device 102.

In some examples, one or more of the apertures 124, 126, 128, 130 include complementary threading to the fastener 122. For example, the aperture 126 within the mounting device 102 may be threaded. In other examples, one or more of the apertures 124, 126, 128, 130 include complementary interlocking features with the fastener 122. For example, the aperture 126 within the mounting device 102 may be include the complementary interlocking features.

However, it should be understood that the mounting system 100 is not limited to the fastener 122. Alternatively, the mounting system 100 may include the fastener 122 for insertion into the aperture 124 of the grab 106 and the aperture 128 of the mount 110, and a second fastener for insertion into the aperture 130 of the riser 108 and the aperture 126 of the mounting device 102, without departing from the scope of the present disclosure.

It is noted that the mounting device 102 is not limited to the embodiment illustrated in the various Figures. Rather, it is contemplated that any mounting device 102 able to engage with a panel projection and which includes the aperture 126 for the fastener 122 that secures the grab 106 and the mounting assembly 104 to the mounting device 102 is usable in, and compatible with, the mounting system 100, without departing from the scope of the present disclosure.

As discussed in detail further herein, assembly of the mounting device 102, the mounting assembly 104, and the grab 106 (e.g., with the insertion of the fastener 122) may secure a PV module 132 positioned within a space defined by the mounting assembly 104 and the grab 106.

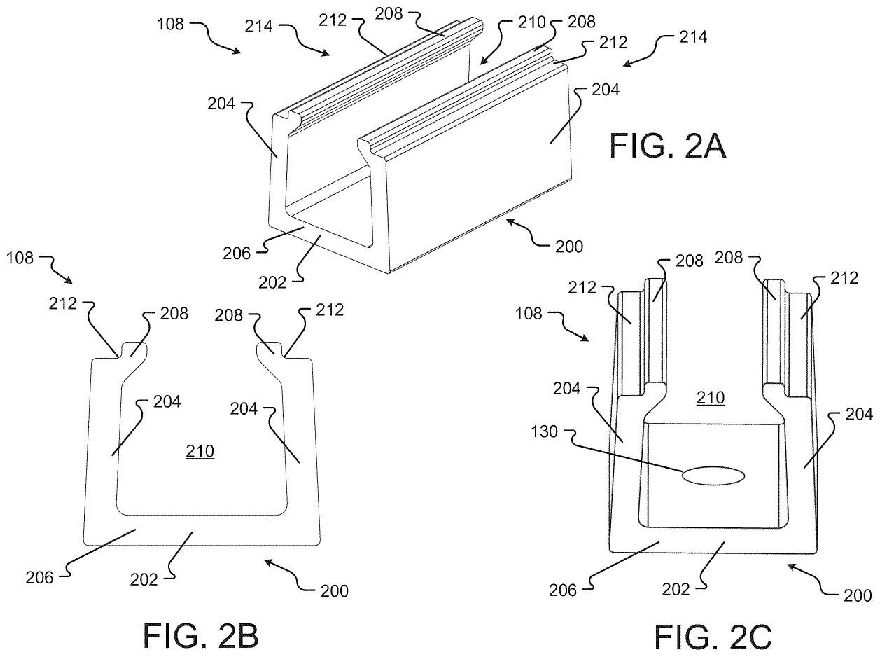

FIGS. 2A-2C illustrate the riser 108 of the mounting assembly 104, in accordance with one or more embodiments of the present disclosure. It should be understood that embodiments directed to the riser 108 in FIGS. 2A-2C are applicable to the riser 108 in FIGS. 1A-1C, and vice versa, without departing from the scope of the present disclosure.

In embodiments, the riser 108 includes a body 200 with a base 202 and one or more sidewalls 204. For example, the sidewalls 204 may include a distal end 206 at the base 202 and a proximal end 208 that extends from the base 202. The body 200 includes the aperture 130, configured to receive the fastener 122 during assembly of the mounting system 100.

The sidewalls 204 define a cavity 210, where the sidewalls 204 are spaced along the length of the sidewalls 204 by one or more widths. However, in alternative embodiments the body 200 may be substantially solid, aside from the aperture 130, such that there is no cavity 210.

In embodiments, the proximal end 208 includes one or more grooves 212 of an interlocking assembly 214. For example, the riser 108 may include a groove 212 on each of the sidewalls 204. It is noted that the engagement of the components of the interlocking assembly 214 is illustrated in FIGS. 1A-1C.

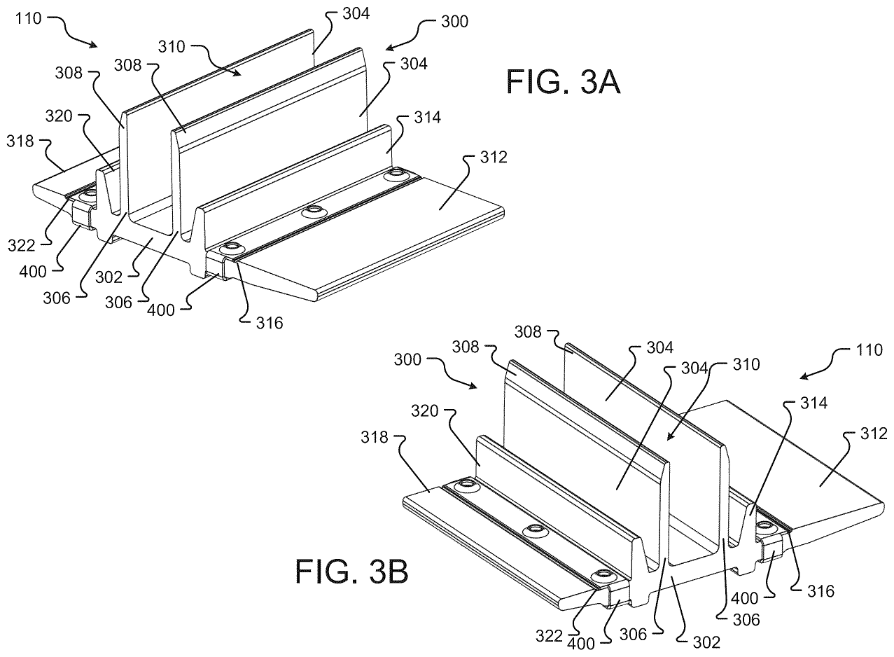

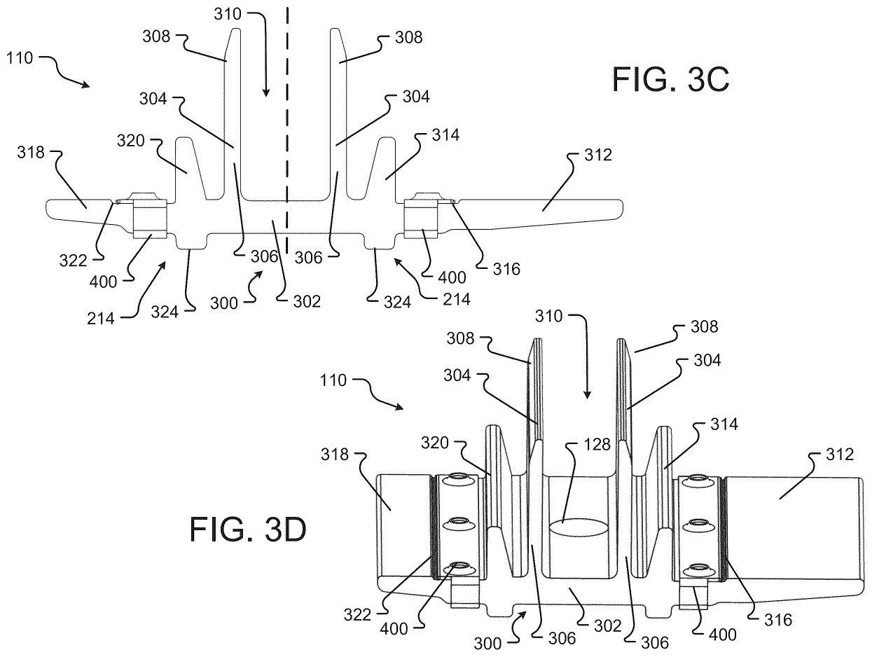

FIGS. 3A-3E illustrate the mount 110 of the mounting assembly 104, in accordance with one or more embodiments of the present disclosure. It should be understood that embodiments directed to the mount 110 in FIGS. 3A-3E are applicable to the mount 110 in FIGS. 1A-1C, and vice versa, without departing from the scope of the present disclosure.

In embodiments, the mount 110 includes a body 300 with a base 302 and one or more sidewalls 304. For example, the sidewalls 304 may include a distal end 306 at the base 302 and a proximal end 308 that extends from the base 302. In some instances, the proximal end 308 is tapered to assist with engagement by the grab 106 on the sidewalls 304, as described in detail further herein. The body 300 includes the aperture 128, configured to receive the fastener 122 during assembly of the mounting system 100.

The sidewalls 304 define a cavity 310, where the sidewalls 304 are spaced from each other along the length of the body 300 by one or more widths. However, in alternative embodiments the body 300 may be substantially solid, aside from the aperture 128, such that there is no cavity 310.

In embodiments, the mount 110 includes one or more PV platforms. The one or more PV platforms, together with the grab 106, secure respective PV modules 132 within the mounting system 100.

For example, the mount 110 may include a first PV platform 312 that extends from the body 300 in a first direction. In some configurations, the first PV platform 312 includes a first edge stop 314 that positions a first PV module 132 a pre-selected distance from a first one of the sidewalls 304 when the first PV module 132 is installed on the PV platform 312. Optionally, the first PV platform 312 is able to receive a first grounding insert 400, as described in detail further herein, including within a first groove 316 that is optional.

By way of another example, the mount 110 may include a second PV platform 318 that extends from the body 300 in a second direction. For instance, the second direction may be opposite the first direction for the first PV platform 312. In some configurations, the second PV platform 318 includes a second edge stop 320 that positions a second PV module 132 a pre-selected distance from a second one of the sidewalls 304 when the second PV module 132 is installed on the second PV platform 318. Optionally, the second PV platform 318 is able to receive a second grounding insert 400, as described in detail further herein, including within a second groove 322 that is optional.

Although the mount 110 is shown with the grounding inserts 400, it should be understood that the mount 110 is not limited to configurations with the grounding inserts 400 (and optional grooves 316, 322 for the grounding inserts 400). In alternative embodiments, surfaces of the PV platforms 312, 318 may have protrusions that engage with respective frames of the PV module 132. In further embodiments, surfaces of the PV platforms 312, 318 may be substantially smooth.

In embodiments, the mount 110 is asymmetric about a plane through the aperture 128 of the mount 110. For example, the first PV platform 312 may be longer than the second PV platform 318. It is contemplated that this difference in length allows for the mount 110 to be installed in a particular orientation on the roof to assist an installer in the placement of the PV modules 132. For example, the PV module 132 may be installed within the longer first PV platform 312 of a first mount 110 at a first point on the roof relative to an apex of the roof. The PV module 132 may then be pivoted into engagement with the short second PV platform 318 of an adjacent mount 110 at a different point on the roof relative to the apex. In this regard, the longer first PV platform 312 may support the PV module on a first mount 110 while the PV module 132 is being installed on a second PV platform 318 on the second adjacent mount 110. It is contemplated, however, that the mount 110 may have mirrored symmetry about the longitudinal axis through the mount 110, without departing from the scope of the present disclosure.

In addition, it is contemplated that forming the mount 110 with the second PV platform 318 that is shorter than the first PV platform 312 beneficially saves material and reduces the cost of the mount 110. Further, the second PV platform 318 being shorter provides a visual indication of an orientation of the mount 110 during installation.

In embodiments, a distal surface of the base 302 includes one or more protrusions 324 of the interlocking assembly 214. For example, in some embodiments, the mount 110 includes a protrusion 324 for each of the grooves 212 on the riser 108 (e.g., as illustrated in FIGS. 2A-2C). Engagement of the protrusions 324 within corresponding grooves 212 on the riser 108 assists in positioning the mount 110 on the riser 108 during installation and assembly of the mounting system 100. It is noted that the engagement of the components of the interlocking assembly 214 is illustrated in FIGS. 1A-1C.

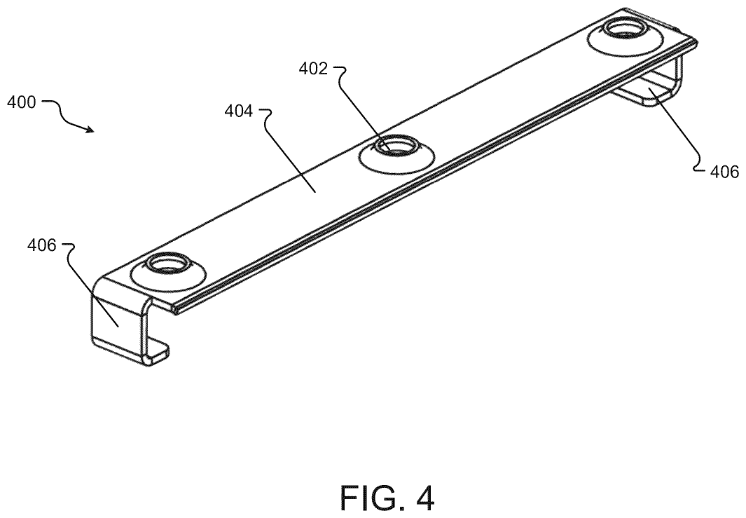

Referring now to FIG. 4, the optional grounding insert 400 is illustrated, in accordance with one or more embodiments of the present disclosure. It should be understood that embodiments directed to the grounding insert 400 in FIG. 4 are applicable to the grounding insert 400 in FIGS. 1A-1C, and vice versa, without departing from the scope of the present disclosure.

The grounding insert 400 includes a plurality of protrusions 402 within a body 404. For example, the body 404 may be dimensioned to fit within a respective groove 316, 322 of a particular PV platform of the mount 110. The body 404 optionally includes tabs or hooks 406 that secure the body 404 to a particular PV platform of the mount 110, either in addition to or instead of the body 404 being inserted into the respective groove of the particular PV platform of the mount 110.

In some configurations, such as when the PV module 132 is secured between the grab 106 and the mount 110, the protrusions 402 may engage with the frame of the PV module 132 to create a grounding path between the frame and the mounting system 100 (and thus the roof to which the mounting system 100 is coupled).

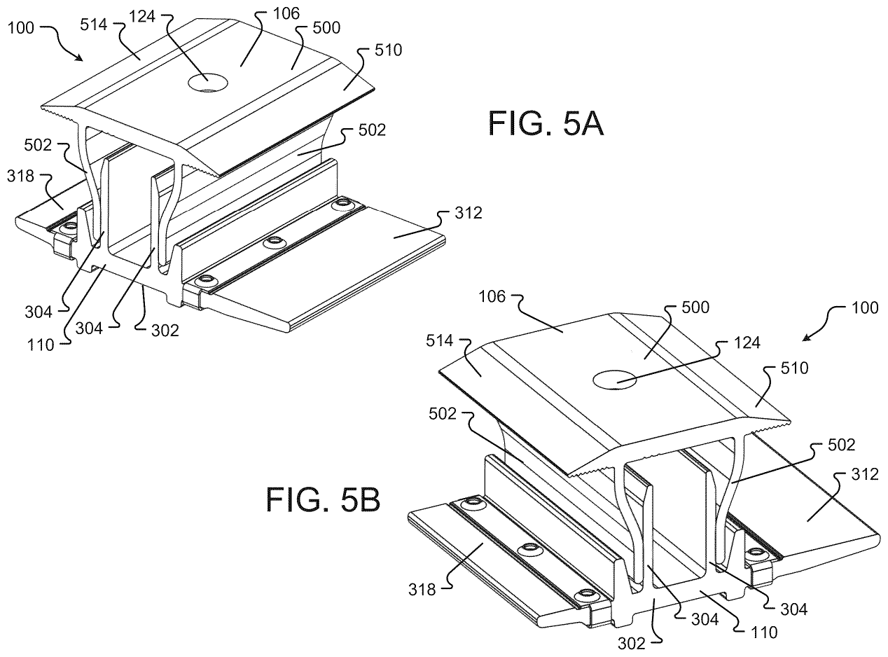

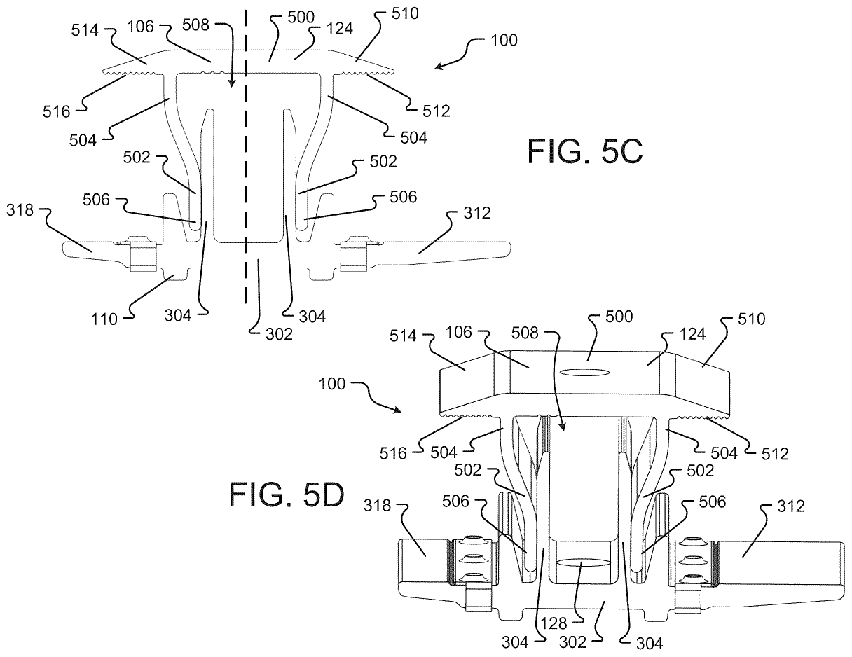

FIGS. 5A-5D illustrate the engagement of the grab 106 onto the mount 110, in accordance with one or more embodiments of the present disclosure. It should be understood that embodiments directed to the grab 106 and the mount 110 in FIGS. 5A-5D are applicable to the grab 106 and the mount 110 in FIGS. 1A-1C, and vice versa, without departing from the scope of the present disclosure.

In embodiments, the grab 106 includes a body 500. The body 500 includes the aperture 124, configured to receive the fastener 122 during assembly of the mounting system 100.

The grab 106 includes one or more legs 502. For example, the legs 502 may include a proximal end 504 at the body 500 and a distal end 506 that extends from the body 500. The legs 502 define a cavity 508, where the legs 502 are spaced from one another along the length of the legs 502 by one or more widths. For example, the legs 502 may have a first width proximate to the proximal end 504, and a second width proximate to the distal end 506, where the second width is less than the first width.

The cavity 508 is dimensioned to receive the sidewalls 304 of the mount 110. During installation of the grab 106 onto the mount 110, the distal end 506 engages with the sidewalls 304 of the mount 110. For example, a width between the legs 502 (i.e., across the cavity) at the location of engagement between the grab 106 and the mount 110 may be less than an outer width of the sidewalls 304 of the mount 110, such that the grab 106 and the mount 110 engage via an interference fit. In some instances, the legs 502 may deflect outward from a longitudinal axis through the grab 106 (i.e., which may be coaxial with the longitudinal axis through the aperture 128 of the mount 110).

It is noted that this interference fit may be beneficial to cause the grab 106 to hold in position on the mount 110 during installation (such as with the distal ends 506 of the grab 106 spaced from the base 302 of the mount 110), to free up the hands of an installer to manipulate other components during installation. It is noted, however, that the width between the legs 502 (i.e., across the cavity) at the location of engagement between the grab 106 and the mount 110 may be equal to or greater than the outer width of the sidewalls 304 of the mount 110, without departing from the scope of the present disclosure.

The grab 106 includes one or more arms. The one or more arms, together with the mount 110, secure respective PV modules 132 within the mounting system 100.

For example, the grab 106 may include a first arm 510 that extends from the body 500 in a first direction. It is noted that the combination of forces applied by the first PV platform 312 of the mount 110 and the first arm 510 of the grab 106 secure a first PV module 132 within the mounting system 100. In some configurations, the first arm 510 includes engagement features 512 that increase the securing force applied to the first PV module 132 (e.g., to a frame of the first PV module 132) held by the first arm 510.

By way of another example, the example, the grab 106 may include a second arm 514 that extends from the body 500 in a second direction. For example, the second direction may be opposite the first direction for the first arm 510. It is noted that the combination of forces applied by the second PV platform 318 of the mount 110 and the second arm 514 of the grab 106 secure a second PV module 132 within the mounting system 100. In some configurations, the second arm 514 includes engagement features 516 that increase the securing force applied to the second PV module (e.g., to a frame of the second PV module 132) held by the second arm 514.

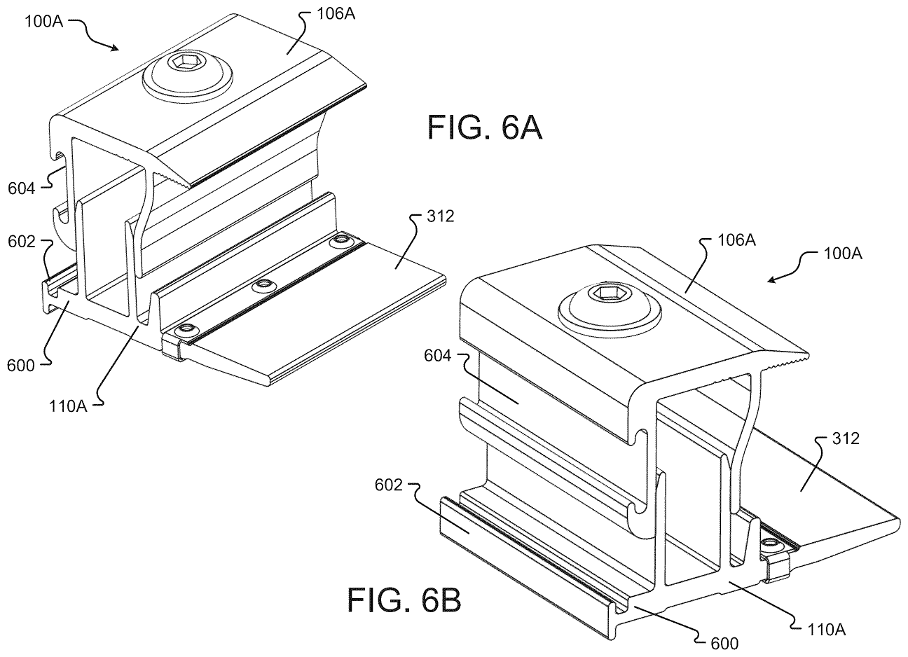

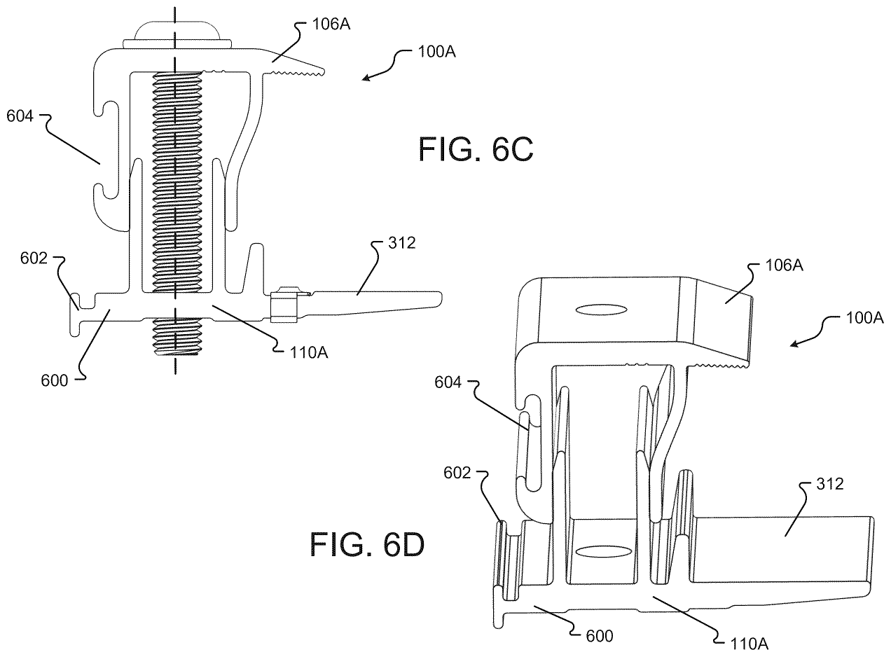

FIGS. 6A-6D illustrate a variation of the mounting system 100, labelled mounting system 100A, includes a variation the grab 106 and the mount 110, in accordance with one or more embodiments of the present disclosure. In particular, a grab 106A and a mount 110A in FIGS. 6A-6D are configured for edge installations, or an installation that is at one end of an array of PV modules 132, as compared to the grab 106 and the mount 110 as generally illustrated in FIGS. 1A-3D and 5A-5D. It should be understood that the grab 106A and/or mount 110A are interchangeable with the grab 106 and/or mount 110 as generally illustrated in FIGS. 1A-3D and 5A-5D, including with respect to the engagement with the mounting device 102, the riser 108, and/or the grounding inserts 400. In addition, it should be understood that features of the grab 106 and the mount 110 should be understood as being features of the grab 106A and the mount 110A, unless otherwise noted, without departing from the scope of the present disclosure.

In embodiments, the mount 110A includes an edge platform 600 in place of the second PV platform 318 (e.g., as illustrated in FIGS. 3A-3D), in combination with the first PV platform 312. The edge platform 600 includes a protrusion 602 or other interlocking feature (e.g., like a groove) that receives and/or engages with attachments to the mounting system 100. In other aspects, the protrusion 602 provides a protection barrier for the mounting system 100 (and the array of PV modules 132, in general).

In embodiments, the grab 106A includes a groove 604 or other interlocking feature (e.g., like a protrusion) in place of the second arm 514 (e.g., as illustrated in FIGS. 5A-5D), where the groove 604 receives and/or engages with attachments to the mounting system 100.

With the inclusion of the edge platform 600 on the mount 110A and the groove 604 on the grab 106A, respectively, the mount 110A and the grab 106A have asymmetry across a plane through the mount 110A and/or the grab 106A.

FIGS. 7A-7D illustrate a variation of the mounting assembly 104, in accordance with one or more embodiments of the present disclosure. In particular, the mounting assembly 104 comprises an integrated mount 700, as compared to the separate riser 108 and mount 110 as generally illustrated in FIGS. 1A-3D and 5A-6D.

It should be understood that the integrated mount 700 is interchangeable with the mounting assembly 104 as generally illustrated in FIGS. 1A-3D and 5A-6D, including with respect to the engagement with the mounting device 102, the grab 106, and/or the grounding inserts 400. In addition, it should be understood that features of the riser 108 and the mount 110 should be understood as being features of the integrated mount 700, unless otherwise noted, without departing from the scope of the present disclosure.

The integrated mount 700 includes a body 702 with a first portion 704 and a second portion 706. For example, the first portion 704 of the body 702 includes features of the riser 108. By way of another example, features of the mount 110 (e.g., the sidewalls 304, the PV platform 312, and the like) extend from (or may be considered components of) the second portion 706 of the body 702. However, as the riser 108 and mount 110 are combined into the integrated mount 700, the integrated mount does not include the interlocking assembly 214 including the groove 212 of the riser 108 and the protrusions 324 of the mount 110.

Being an integrated component, it is noted that the integrated mount 700 includes both the aperture 128 (i.e., from the mount 110) and the aperture 130 (i.e., from the riser 108) for the insertion of the fastener 122 during assembly of the mounting system 100.

It is noted that the first portion 704 and the second portion 706 are illustrated with the PV platform 312 and the edge platform 600 with the protrusion 602 from the mount 110A from FIGS. 6A-6D. However, it should be understood that the integrated mount 700 may instead include the second PV platform 318 from FIGS. 3A-3D, without departing from the scope of the present disclosure.

It is contemplated that the body 702 may not include a surface 708 with the aperture 128, such that the body 702 only includes the aperture 130. For example, cavities defined with the body 702 that correspond to cavities 210, 310 of the riser 108 and mount 110, respectively, that are separated by a surface 708 may instead be a single cavity defined within the body 702 between sidewalls that correspond to sidewalls 204 and 304 of the riser 108 and mount 110, respectively.

It is noted that one or more of the components of the mounting system 100 may be fabricated from a metal. For example, the components may be fabricated from an extruded or machined aluminum. By way of another example, the components may be fabricated (e.g., casted, stamped, machined, or the like) from a steel.

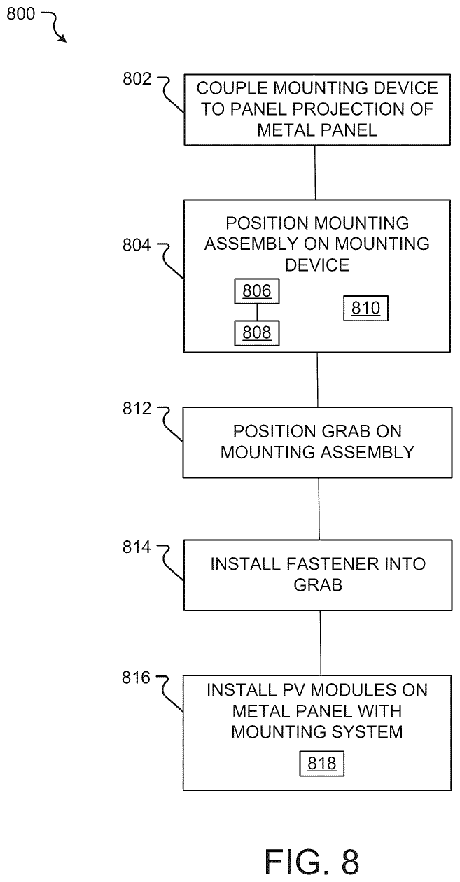

FIG. 8 is a flow diagram of a method or process 800 illustrating the installation and operation of the mounting system 100, in accordance with one or more embodiments or the present disclosure. While a general order for the method or process is shown in FIG. 8, the method or process can include more or fewer operations or can arrange the order of the operations differently (including simultaneously, substantially simultaneously, or sequentially) than those shown in FIG. 8. It is noted that the method or process shall be explained with reference to the components, devices, subassemblies, environments, etc. described in conjunction with FIGS. 1A-7D. For example, it is noted that the embodiments as illustrated in FIGS. 1A-7D should be understood as reading on the embodiments described with respect to FIG. 8, and vice versa, without departing from the scope of the present disclosure.

In embodiments, a mounting device is coupled 802 to a panel projection of a metal panel. The mounting device 102 may be coupled to the panel projection of the metal panel via one or more fasteners within corresponding apertures 112 in the mounting device 102.

In embodiments, a mounting assembly is positioned 804 on the mounting device 102. For example, positioning the mounting assembly 104 may include positioning 806 a riser 108 on the mounting device 102, and positioning 808 a mount 110 on the riser 108. By way of another example, positioning the mounting assembly 104 may include positioning 810 an integrated mount 700 on the mounting device 102.

In embodiments, a grab is positioned 812 of the mounting assembly. For example, the grab 106 may engage sidewalls 304 of the mount 110 or the integrated mount 700.

In embodiments, a fastener is installed 814 in the grab. In some instances, installation of the fastener completes assembly of the mounting system 100. For example, the fastener 122 may be inserted through the aperture 124 of the grab 106, and the aperture 128 of the mount 110 and the aperture 130 of the riser 108 (or the apertures 128, 130 of the integrated mount 700), to engage the aperture 126 on the mounting device 102. By way of another example, a first fastener may be installed in the aperture 124 of the grab 106 and the aperture 128 of the mount 110/integrated mount 700, and a second fastener may be installed in the aperture 130 of the riser 108/integrated mount 700 and the aperture 126 of the mounting device 102.

In embodiments, one or more PV modules are installed 816 on the metal panel with the mounting system. Optionally, such as where the grab is not pre-set at a height from the mount to secure the PV modules, the PV modules are engaged 818 with the grab. For example, a first PV module 132 may be installed on, and secured by, a first arm 510 of the grab 106/grab 106A and a first PV platform 312 of the mount 110/mount 110A/integrated mount 700. By way of another example, a second PV module 132 may be installed on, and secured by, a second arm 514 of the grab 106 and a second PV platform 318 of the mount 110/integrated mount 700. It is noted that the installation of the PV modules 132 may be performed by the same individual or different individuals at the same time or different times, such as where a first installer places mounting systems on the metal panel and a second installer places the PV modules 132 on the mounting systems 100.

Although embodiments of the present disclosure are directed to assembling the mounting system 100 on the metal panel, it is contemplated that the mounting system 100 may be assembled on a ground surface (i.e., prior to installation on the metal panel), and the assembled mounting system 100 may be installed as a single unit on the metal panel. For example, the stacking of the mounting device 102, mounting assembly 104, and grab 106 for insertion of the fastener 122 may occur on the ground surface to form the mounting system 100, and the complete mounting system 100 may be installed on the panel projection using a fastener through the aperture 112 in the mounting device 102 without departing from the scope of the present disclosure.

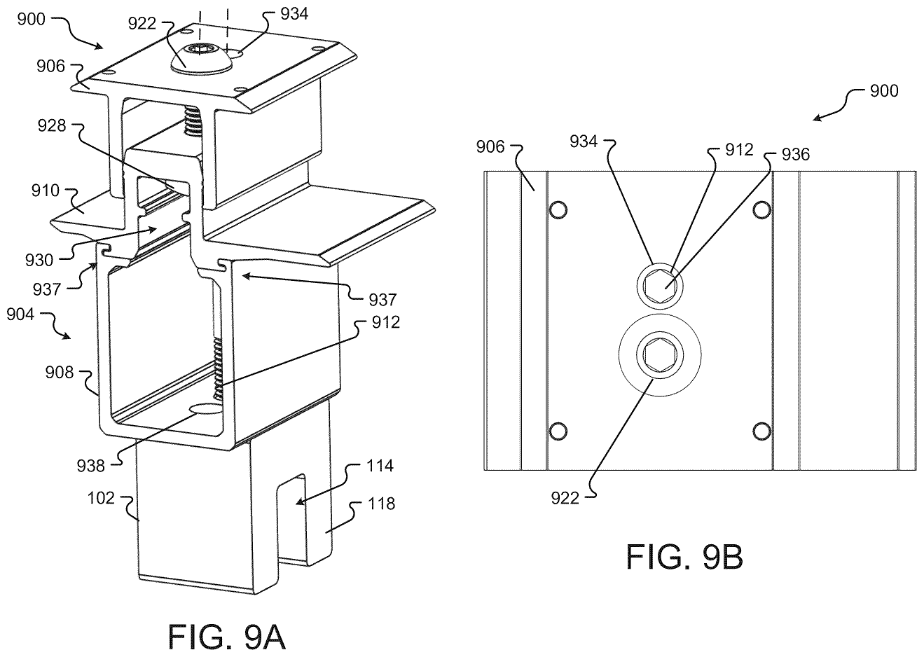

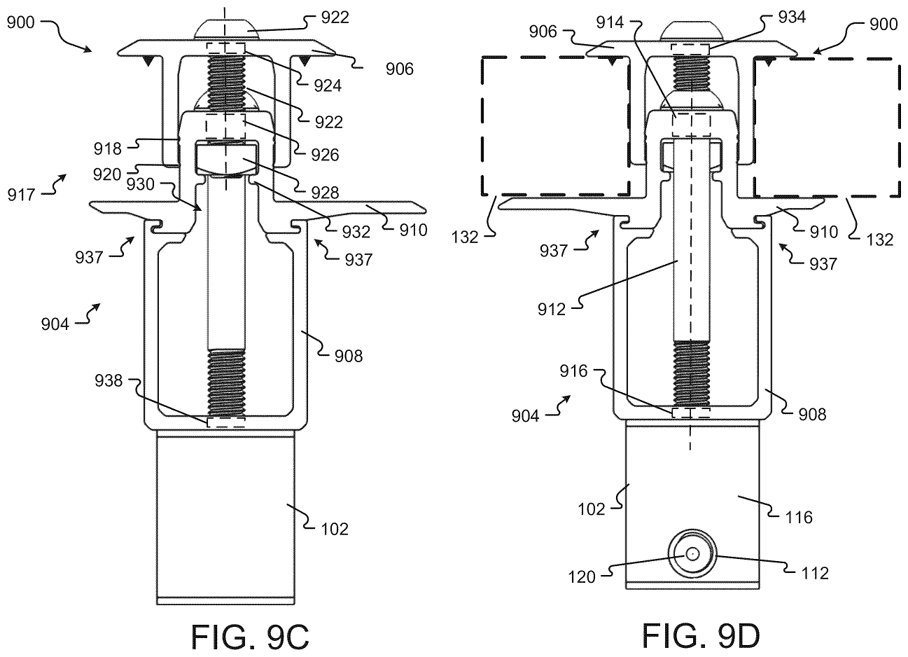

FIGS. 9A-9D illustrate a mounting system 900, in accordance with one or more embodiments of the present disclosure. The mounting system 900 includes the mounting device 102 with a mounting assembly 904 and a grab 906. It should be understood that embodiments directed to the mounting device 102 in the mounting system 100 of FIGS. 1A-1C are applicable to the mounting device 102 in the mounting system 900 of FIGS. 9A-9D, and vice versa, without departing from the scope of the present disclosure.

In embodiments, the mounting assembly 904 includes a riser 908 and a mount 910. For example, the riser 908 and the mount 910 are separate components, where the mount 910 is positionable on the riser 908 between the mounting device 102 and the grab 906.

In some configurations, the mounting device 102, the mounting assembly 904 (e.g., including the riser 908 and/or the mount 910), and the grab 906 are each separate components. Being fabricated separately, one or more of the mounting device 102, the mounting assembly 904 (e.g., including the riser 908 and/or the mount 910), and the grab 906 may be pre-assembled by the manufacturer/distributor, and/or may be pre-assembled by an installer on a job site prior to installation (e.g., including on a ground surface, prior to ascending onto the metal panel with the panel projections).

The mounting system 900 is capable of being pre-assembled and installed as a single unit on the metal panel. For example, the components may be pre-assembled as the mounting system 900 together in a first pre-installation configuration, which then may be adjusted by an installer to a second post-installation configuration that secures PV modules 132 to the metal panel (e.g., after placement of the mounting system 900 on the metal panel and supporting of PV modules 132 on the metal panel by the mounting system 900).

In embodiments, the mounting system 900 includes a fastener 912, which is usable to secure components of the mounting system 900 together. For example, the fastener 912 may pass through one or more apertures in the mounting assembly 904 and engage with the aperture 126 in the mounting device 102. For instance, the mounting assembly 904 may include an aperture 914 in the mount 910 and an aperture 916 in the riser 908 that receives the fastener 912 prior to the fastener 912 being inserted into the aperture 126 of the mounting device 102.

It is noted that the aperture 126 of the mounting device 102 may be threaded to engage with complementary threading on the fastener 912. Alternatively, a second fastener (e.g., a nut, a cotter pin, or other fastener) may be located within the cavity 114 and able to receive the fastener 912 after it passes through the aperture 126 (e.g., which may be smooth-bore or threaded) to secure the mounting assembly 904 to the mounting device 102.

In embodiments, the mount 910 and the grab 906 includes at least one interlocking assembly 917. For example, the interlocking assembly 917 may include a groove 918 in the mount 910, and a protrusion 920 on the grab 906 (although it is contemplated that the arrangement of the groove 918 and the protrusion 920 may be reversed, without departing from the scope of the present disclosure).

When the interlocking assembly 917 is engaged, the grab 906 is positioned in a first configuration relative to the mounting assembly 904 (and the mounting device 102). The engagement of the interlocking assembly 917 positions the grab 906 at a pre-determined location within the mounting system 900 relative to the mount 910, to allow for insertion of a PV module 132 between the grab 906 and the mount 910. For example, when the interlocking assembly 917 is engaged, distal ends of the grab 906 may be spaced (and retaining) a first distance from one or more PV platforms of the mount 910.

When the interlocking assembly 917 is disengaged, however, the grab 906 may be positioned in a second configuration relative to the mounting assembly 904 (and the mounting device 102). The disengagement of the interlocking assembly 917 may position the grab 906 at a second location within the mounting system 900 relative to the mount 110 which secures the PV module 132 between the grab 906 and the mount 910. Alternatively, the disengagement of the interlocking assembly 917 may allow for removal of the grab 906 from the mounting assembly 904 (and the mounting device 102). For example, when the interlocking assembly 917 is disengaged, the distal ends of the grab 906 are spaced a second distance from the one or more PV platforms of the mount 910. Optionally, the second distance is less than the first distance.

In embodiments, the mounting system includes a fastener 922, which is usable to secure components of the mounting system 900 together. For example, the fastener 922 may pass through an aperture 924 in the grab 906 and through one or more apertures in the mounting assembly 904. For instance, the mounting assembly 904 may include an aperture 926 in the mount 110 that receives the fastener 922 after the fastener 922 is inserted through the aperture 924 of the grab 906.

Where the mount 910 is installed with the riser 908 in the mounting system 900, it is noted that a second fastener 928 (e.g., as illustrated in FIGS. 9A and 9C) may be installed within a cavity 930 defined within the mount 910. For example, the second fastener 928 may include a nut, a cotter pin, or other fastener able to engage with the fastener 922 after it passes through the aperture 924 (e.g., which may be smooth-bore or threaded) to secure the grab 906 to the mounting assembly 904. In some configurations, the mount 910 may include one or more protrusions 932 to support and/or secure the fastener 928 within the cavity 930. Alternatively, the aperture 926 of the mount 910 may be threaded to engage with complementary threading on the fastener 922.

In some configurations, continued rotation of the fastener 922 to increase engagement with the aperture 924 of the mount 910 shortens a height between adjacent surfaces of the grab 906 and the mount 910. At some pre-determined point, the interlocking assembly 917 is disengaged by the continued rotation of the fastener 922, causing the grab 906 to transition between the first pre-installation configuration to a second post-installation configuration that secures PV modules 132 to the metal panel. It is noted that FIGS. 9A-9D illustrate the grab 906 at (or transitioning to) the second post-installation configuration, with the protrusion 920 of the grab 906 disengaged from the groove 918 of the mount 910.

It should be understood that the direction of insertion of the fasteners 912, 922 is substantially identical when assembling the mounting system 900. For example, both of the fasteners 912, 922 are inserted from a more-proximal end of the mounting system 900 (e.g., proximate to the grab 906) and toward the mounting device 102 located at a more-distal end of the mounting system 900. In this regard, the fasteners 912, 922 are more accessible by both an assembler of the mounting system 900 and an installer of the PV module 132, whether the same individual or different individuals, as compared to known solutions where components of a PV module mounting system are inserted in multiple different directions during assembly and/or installation. In some configurations, the direction of insertion for the fasteners 912, 922 is angled (e.g., including, but not limited to, at an oblique angle, or at a substantially perpendicular or orthogonal angle) to a direction of extrusion for one or more of the grab 906, the riser 908, and/or the mount 910.

It is contemplated that insertion of a fastener into the aperture 112 of the mounting device 102 (which is optionally aligned with an opposite recess 120 in the mounting device 102) may be substantially parallel with or may be angled (e.g., including, but not limited to, at an oblique angle, or at a substantially perpendicular or orthogonal angle) to the direction of insertion of the fastener 912 and/or the fastener 922, without departing from the scope of the present disclosure. In some instances, the insertion of the fastener within the aperture 112 of the mounting device 102 is angled (e.g., including, but not limited to, at an oblique angle, or at a substantially perpendicular or orthogonal angle) to a direction of extrusion for the mounting device 102.

In part because of the direction of insertion of the fasteners 912, 922 being substantially identical, in some configurations the fastener 912 may be at least partially covered by the grab 906 including where the grab 906 is assembled on the mount 910 in the first pre-installation position. To provide access to the fastener 912 after coupling of the grab 906 to the mounting assembly 904, in some embodiments the grab 906 may include an aperture 934, through which a tool may be inserted to engage with a tool engagement feature 936 on the fastener 912. For example, the aperture 934 may be beneficial where the connection of the fastener 912 to the mounting device 102 needs to be adjusted, including optionally after assembly of the mounting system 900 and/or installation of the mounting system 900 onto the panel projection of the metal panel.

It is noted that the fasteners 912, 922 may include longitudinal axes that are substantially parallel but offset to prevent interference. The offsetting of the longitudinal axes allows for the inclusion of both fasteners 912, 922 such that the fastener 912 provides an additional securing force between the mount 910 and the riser 908 in addition to the coupling of one or more shared interlocking assemblies 937 on the mount 910 and the riser 908 of the mounting assembly 904, and the fastener 922 secures the grab 906 to the mount 910 in addition to the one or more shared interlocking assembly 917 on the grab 906 and the mount 910.

However, it is contemplated that the length of the fasteners 912, 922 may be such that the longitudinal axes through the fasteners 912, 922 may be aligned. For example, the fastener 912 may be inserted into the riser 908 and the mounting device 102. Next, the riser 908 and the mount 910 are coupled together via the at least one interlocking assembly 937. Where the grab 906 is installed on the mount 910 in the first pre-installation position, the tool engagement feature 936 on the fastener 912 may still be engaged via insertion of a tool through the aperture 934 on the grab 906 and the aperture 924 on the mount 910 to interact with the fastener 912 within the aperture 926 of the riser 908. The fastener 922 may then be inserted into the aperture 934 of the grab 906 and the aperture 924 of the mount 910 (and optionally the fastener 928 within the cavity 930), such that the longitudinal axes of the fastener 922 and the fastener 912 are aligned.

Although embodiments of the present disclosure are directed to separate fasteners 912, 922 for the mounting assembly 904 and the grab 906 in the mounting system 900, it is contemplated that the riser 908 may include an aperture 938 that aligns with the apertures 924, 926 for the fastener 922. Here, the fastener 922 may pass through the grab 906, the mount 910, and the riser 908 before being inserted into (or through) the aperture 126 on the mounting device 102. In this configuration, at least the fastener 912 is not required in the mounting system 900 (and, optionally, the apertures 914, 916 may not be included within the mount 910 and the riser 908, respectively).

In some examples, one or more of the apertures 126, 914, 916, 924, 926, 934, 938 may include complementary threading to the fastener 912 or the fastener 922. For example, the aperture 126 within the mounting device 102 may include threading that is complementary to threading on the fastener 912. In other examples, one or more of the apertures 126, 914, 916, 924, 926, 934, 938 include complementary interlocking features with the fastener 912 or the fastener 922. For example, the aperture 126 within the mounting device 102 may include the complementary interlocking features with the fastener 912.

It is noted that the mounting device 102 is not limited to the embodiment illustrated in the various Figures. Rather, it is contemplated that any mounting device 102 able to engage with a panel projection and which includes the aperture 126 for the fastener 912 or the fastener 922 that secures the grab 906 and the mounting assembly 904 to the mounting device 102 is usable in the mounting system 900, without departing from the scope of the present disclosure.

As discussed in detail further herein, assembly of the mounting device 102, the mounting assembly 904, and the grab 906 (e.g., with the insertion of one or more of the fasteners 912 and 922) may secure the PV module 132 positioned within a space defined by the mounting assembly 904 and the grab 906.

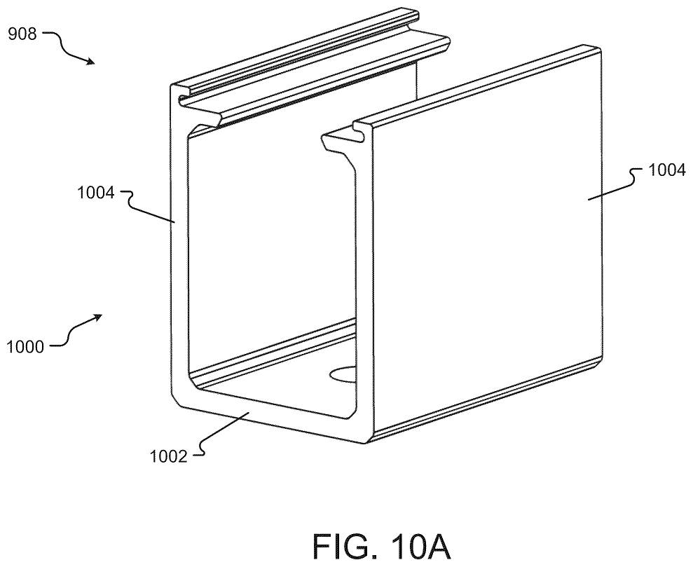

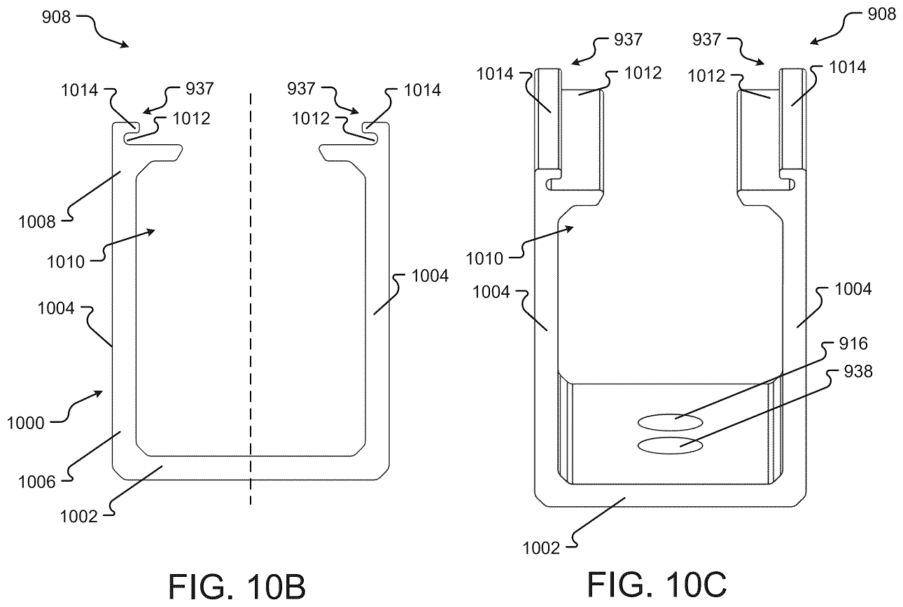

FIGS. 10A-10C illustrate the riser 908 of the mounting system 900, in accordance with one or more embodiments of the present disclosure. It should be understood that embodiments directed to the riser 908 in FIGS. 10A-10C are applicable to the riser 908 in FIGS. 9A-9D and/or the riser 108 of the FIGS. 2A-2C, and vice versa, unless otherwise noted without departing from the scope of the present disclosure.

In embodiments, the riser 908 includes a body 1000 with a base 1002 and one or more sidewalls 1004. For example, the sidewalls 1004 may include a distal end 1006 at the base 1002 and a proximal end 1008 that extends from the base 1002. The body 1000 includes the aperture 916 configured to receive the fastener 912 during assembly of the mounting system 900. Optionally, the body 1000 additionally includes the aperture 938.

The sidewalls 1004 define a cavity 1010, where the sidewalls 1004 are spaced along the length of the sidewalls 1004 by one or more widths. However, in alternative embodiments the body 1000 may be substantially solid, aside from the apertures 916 and 938, such that there is no cavity 1010.

In embodiments, a proximalmost portion of the sidewalls 1004 includes one or more notches 1012 and one or more protrusions 1014 of interlocking assemblies 937 shared with the mount 910. It is noted that the engagement of the components of the interlocking assemblies 937 is illustrated in FIGS. 9A-9D.

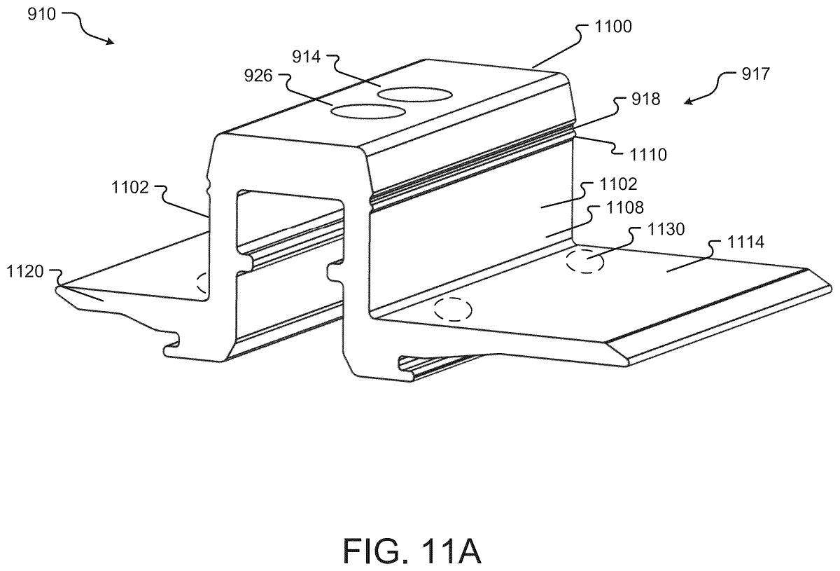

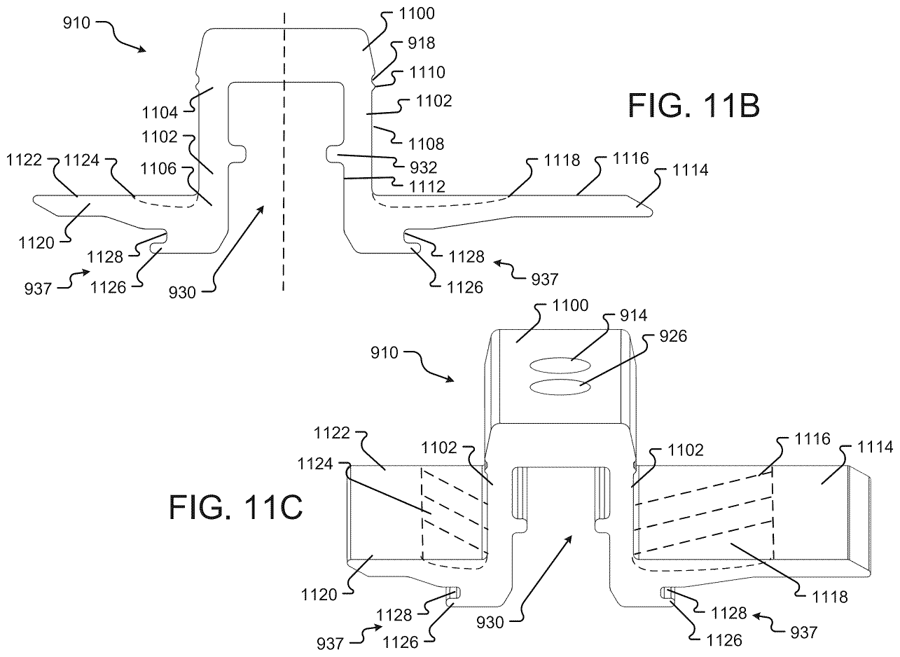

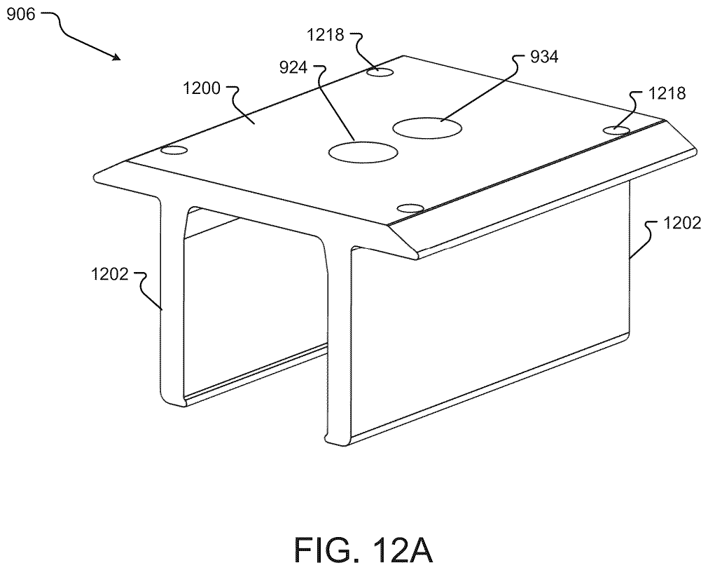

FIGS. 11A-11C illustrate the mount 910 of the mounting system 900, in accordance with one or more embodiments of the present disclosure. It should be understood that embodiments directed to the mount 910 in FIGS. 11A-11C are applicable to the mount 910 in FIGS. 9A-9D and/or the mount 110 of FIGS. 3A-3C, and vice versa, unless otherwise noted without departing from the scope of the present disclosure.

In embodiments, the mount 910 includes a body 1100. The body 1100 includes the aperture 926 configured to receive the fastener 912 during assembly of the mounting system 900. The body 1100 additionally includes the aperture 914 configured to receive the fastener 922 during assembly of the mounting system 900.

In embodiments, the mount 910 includes one or more legs 1102. For example, the legs 1102 may include a proximal end 1104 at the body 1100 and a distal end 1106 that extends from the body 1100. The legs 1102 define the cavity 930, where the legs 1102 are spaced from one another along the length of the legs 1102 by one or more widths. For example, the legs 1102 may have a first width proximate to the proximal end 1104, and a second width proximate to the distal end 1106, where the second width is equal to or greater than the first width. However, in alternative embodiments the body 1100 may be substantially solid, aside from the apertures 914 and 926, such that there is no cavity 930.

The legs 1102 include the groove 918 of the one or more interlocking assemblies 917. For example, the groove 918 may be within an exterior surface 1108 of the legs 1102. By way of another example, the groove 918 may be positioned adjacent to at least one protrusion 1110 (or located between flanking protrusions 1110) on the exterior surface 1108 of the legs 1102. It is noted that the groove 918 may be entirely within a particular leg 1102, or may be at a transition region between the body 1100 and a particular leg 1102, without departing from the scope of the present disclosure. For example, the leg 1102 may have a single protrusion 1110, and the body 1100 may form a second protrusion that together flank the groove 918.

Where the mount 910 includes the one more protrusions 932 (e.g., for a fastener 928), the one or more protrusions 932 may extend into the cavity 930 from interior surfaces 1112 of the legs 1102. For example, the mount 910 may include two protrusions 932 which extend into the cavity 930 and toward one another from respective interior surfaces 1112 of respective legs 1102. In some configurations, the two protrusions 932 extend along axes that are substantially co-axial (and which, when considering a third dimension such as in a direction of extrusion, extend along planes that are substantially co-planar).

In embodiments, the mount 910 includes one or more PV platforms. The one or more PV platforms, together with the grab 906, secure respective PV modules 132 within the mounting system 900 (e.g., as illustrated in FIG. 9D).

For example, the mount 910 may include a first PV platform 1114 that extends from a first leg 1102 in a first direction. The first PV platform 1114 includes a surface 1116 that supports a first PV module 132. In some configurations, the surface 1116 is substantially planar. In other configurations, the surface 1116 optionally includes a concavity 1118 for the first PV module 132, where material is removed the surface 1116 (or not formed with, during fabrication). For example, the concavity 1118 allows for the first PV module 132 to be pivoted into position on the first PV platform 1114, including where the grab 906 is in the first pre-installation position with the one or more interlocking assemblies 917 engaged.

By way of another example, the mount 910 may include a second PV platform 1120 that extends from a second leg 1102 in a second direction. The second PV platform 1120 includes a surface 1122 that supports a second PV module 132. In some configurations, the surface 1122 is substantially planar. In other configurations, the surface 1122 optionally includes a concavity 1124 for the second PV module 132, where material is removed the surface 1122 (or not formed with, during fabrication). For example, the concavity 1124 allows for the second PV module 132 to be pivoted into position on the second PV platform 1120, including where the grab 906 is in the first pre-installation position with the one or more interlocking assemblies 917 engaged.

Optionally, the first PV platform 1114 and/or the second PV platform 1120 is able to receive a grounding insert 400, as described in detail previously herein, including within an optional groove within the respective surfaces 1116, 1122 of the PV platforms 1114, 1120. Alternatively, the respective surfaces 1116, 1122 of the PV platforms 1114, 1120 may have protrusions that engage with respective frames of the PV module 132. Further, the respective surfaces 1116, 1122 of the PV platforms 1114, 1120 may be substantially smooth. In some configurations, the surfaces 1116, 1122 of the PV platforms 1114, 1120 are approximately co-planar.

In embodiments, the mount 910 is asymmetric about a longitudinal axis through the cavity 930 of the mount 910. For example, the first PV platform 1114 may be longer than the second PV platform 1120. It is contemplated that this difference in length allows for the mount 910 to be installed in a particular orientation on the roof to assist an installer in the placement of the PV modules 132. For example, the PV module 132 may be installed within the longer first PV platform 1114 of a first mount 910 at a first point on the roof relative to an apex of the roof. The PV module 132 may then be pivoted into engagement with the short second PV platform 1120 of an adjacent mount 910 at a different point on the roof relative to the apex. In this regard, the longer first PV platform 1114 may support the PV module on a first mount 910 while the PV module 132 is being installed on a second PV platform 1120 on the second adjacent mount 910. It is contemplated, however, that the mount 910 may have mirrored symmetry about the longitudinal axis through the mount 910, without departing from the scope of the present disclosure.

In addition, it is contemplated that forming the mount 910 with the second PV platform 1120 that is shorter than the first PV platform 1114 beneficially saves material and reduces the cost of the mount 910. Further, the second PV platform 1120 being shorter provides a visual indication of an orientation of the mount 910 (and thus the mounting system 900) during installation.

In embodiments, a distalmost portion of the legs 1102 includes one or more protrusions 1126 and one or more notches 1128 of interlocking assemblies 937 shared with the riser 908. For example, in some embodiments, the mount 910 includes a protrusion 1126 for each of the notches 1012 on the riser 908, and/or a notch 1128 for each of the protrusions 1014 on the riser 908 (e.g., as illustrated in FIGS. 10B-10C). Engagement of the protrusions 1126 within corresponding notches 1012 on the riser 908, and notches 1128 receiving corresponding protrusions 1014 on the riser 908, assists in positioning the mount 910 on the riser 908 during installation and assembly of the mounting system 900. It is noted that the engagement of the components of the interlocking assemblies 937 is illustrated in FIGS. 9A-9D.

In some configurations, the sidewalls 1004 of the riser 908 are rigid enough that the mount 910 must be slid into the riser 908 (e.g., along a direction of extrusion for the riser 908 and/or the mount 910) to couple the protrusions 1126 and notches 1128 with corresponding notches 1012 and protrusions 1014 of the interlocking assemblies 937 shared by the riser 908 and the mount 910. In other configurations, the sidewalls 1004 of the riser 908 may have enough pliancy to allow for the mount 910 to snap into the riser 908 when engaging the shared interlocking assembly 937, without adversely affecting the supportive nature of the riser 908 for a PV module 132 when installed on the metal panel via the mounting system 900.

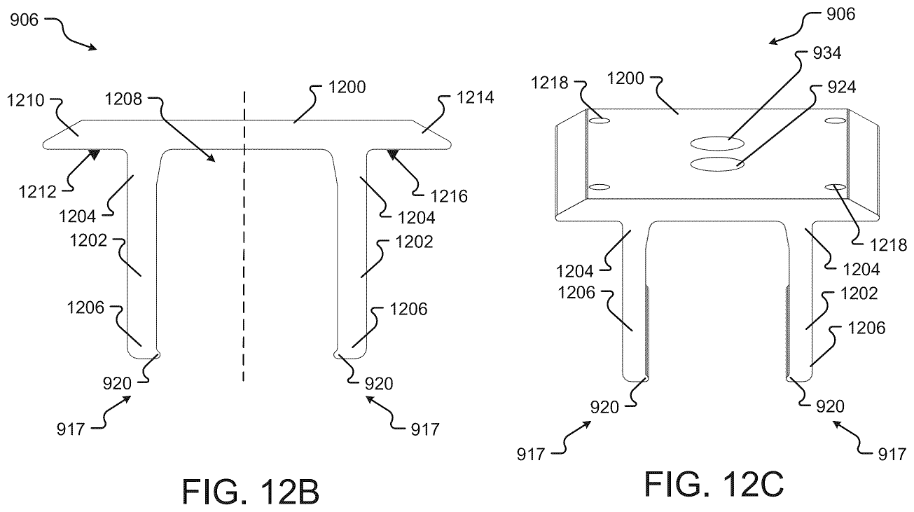

FIGS. 12A-12C illustrate the grab 906 of the mounting system 900, in accordance with one or more embodiments of the present disclosure. It should be understood that embodiments directed to the grab 906 in FIGS. 12A-12C are applicable to the grab 906 in FIGS. 9A-9D and the grab 106 in FIGS. 5A-5D, and vice versa, unless otherwise noted without departing from the scope of the present disclosure.

In embodiments, the grab 906 includes a body 1200. The body 1200 includes the aperture 924 configured to receive the fastener 922 during assembly of the mounting system 900. The body 1200 additionally includes the aperture 926, configured to receive a tool to allow for engagement with tool engagement features 936 on the fastener 912.

In embodiments, the grab 906 includes one or more legs 1202. For example, the legs 1202 may include a proximal end 1204 at the body 1200 and a distal end 1206 that extends from the body 1200. Interior surfaces of the legs 1202 define a cavity 1208, where the legs 1202 are spaced from one another along the length of the legs 1202 by one or more widths. For example, the legs 1202 may have a first width proximate to the proximal end 1204, and a second width proximate to the distal end 1206, where the second width is equal to or greater than the first width.

The cavity 1208 of the grab 906 is dimensioned to receive the legs 1102 of the mount 910. As illustrated in FIGS. 11A-11C, exterior surfaces of the legs 1102 of the mount 910 are separated by a second distance that is less than at least the second width between the legs 1202. Accordingly, the body 1100 and the legs 1102 of the mount 910 can at least partially fit into the cavity 1208 of the grab 906 (e.g., as illustrated in FIGS. 9A-9D).

During installation of the grab 906 onto the mount 910, the legs 1202 of the grab 906 engage with the legs 1102 of the mount 910. In some configurations, the legs 1202 of the grab 906 engage exterior surfaces of the legs 1102 of the mount 910.

For example, protrusions 920 of interlocking assemblies 917 at the distal end 1206 of the legs 1202 engage with grooves 918 at proximal ends 1106 of the legs 1102 of the mount 910. In some instances, the legs 1202 may deflect outward from a longitudinal axis through the grab 906 (i.e., which may be coaxial with the longitudinal axis through the mount 910).

It is noted that the interlocking assemblies 917 are beneficial to cause the grab 906 to hold in position on the mount 910 as a pre-installation assembly and later during installation, to free up the hands of an installer to manipulate other components during installation. The grab 906 being in the first pre-installation position may be overcome with a sufficient force to the grab 906 either directly by the installer or indirectly via the installer rotating the fastener 922 to cause the grab 906 to draw toward the mount 910.

The grab 906 includes one or more arms. The one or more arms, together with the mount 910, secure respective PV modules 132 within the mounting system 900.

For example, the grab 906 may include a first arm 1210 that extends from the body 1200 in a first direction. It is noted that the combination of forces applied by the first PV platform 1114 of the mount 910 and the first arm 1210 of the grab 906 secure a first PV module 132 within the mounting system 900. In some configurations, the first arm 1210 includes engagement features 1212 that increase the securing force applied to the first PV module 132 (e.g., to a frame of the first PV module 132) held by the first arm 1210.

By way of another example, the example, the grab 906 may include a second arm 1214 that extends from the body 500 in a second direction. For example, the second direction may be opposite the first direction for the first arm 1210. It is noted that the combination of forces applied by the second PV platform 1120 of the mount 910 and the second arm 1214 of the grab 906 secure a second PV module 132 within the mounting system 900. In some configurations, the second arm 1214 includes engagement features 1216 that increase the securing force applied to the second PV module (e.g., to a frame of the second PV module 132) held by the second arm 1214.

In some configurations, a lower surface of the first arm 1210 (e.g., the surface of the first arm 1210 that faces the mount 910 when the mounting system 900 is assembled) and a lower surface of the second arm 1214 (e.g., the surface of the second arm 1214 that faces the mount 910 when the mounting system 900 is assembled) are approximately co-planar.

It is noted that the engagement features 1212, 1216 may be inserted (e.g., threaded, press-fit, or the like) into the respective arms 1210, 1214. For example, in some embodiments the body 1200 includes one or more grooves or apertures 1218 to receive the engagement features 1212, 1216. However, it is contemplated that the engagement features 1212, 1216 may be surface-mounted on the respective arms 1210, 1214, or may be integrally formed with the respective arms 1210, 1214, without departing from the scope of the present disclosure.

Optionally, the engagement features 1212, 1216 are further configured to engage with the frame of a respective PV module 132 to create a grounding path between the frame and the mounting system 900. The engagement features 1212, 1216 may facilitate establishing an electrical connection with and/or grounding of one or more photovoltaic modules. In some embodiments, the engagement features 1212, 1216 may comprise a sharpened point or edge to pierce or penetrate a surface or surface coating of a frame/frame section of a PV module 132 to establish an electrical connection with the underlying metal of the frame/frame section. The engagement features 1212, 1216 may be characterized as providing electrical continuity between the PV module 132 and the grab 906 and the mounting assembly 904. This may be referred to in the art as “bonding.” In any case, the engagement features 1212, 1216 may be used in providing a grounding function for a corresponding PV module 132. The electrical connection provided by the engagement features 1212, 1216 may be used to electrically connect adjacent PV modules 132.

Referring again to FIG. 11A, although not shown it is noted that engagement features similar to engagement features 1212, 1216 may be inserted (e.g., threaded, press-fit, or the like) into respective surfaces 1116, 1122 of the PV platforms 1114, 1120 of the mount 910. For example, the respective surfaces 1116, 1122 of the PV platforms 1114, 1120 may include grooves or apertures 1130 to receive the engagement features. However, it is contemplated that the engagement features may be surface-mounted on the respective surfaces 1116, 1122 of the PV platforms 1114, 1120, or may be integrally formed with the respective surfaces 1116, 1122 of the PV platforms 1114, 1120, without departing from the scope of the present disclosure.

Although embodiments of the present disclosure are directed to a particular mounting system 900 including one of each of the mounting device 102, the mounting assembly 904, the grab 906, and the riser 908, it is noted that this is one non-limiting configuration for the mounting system 900.

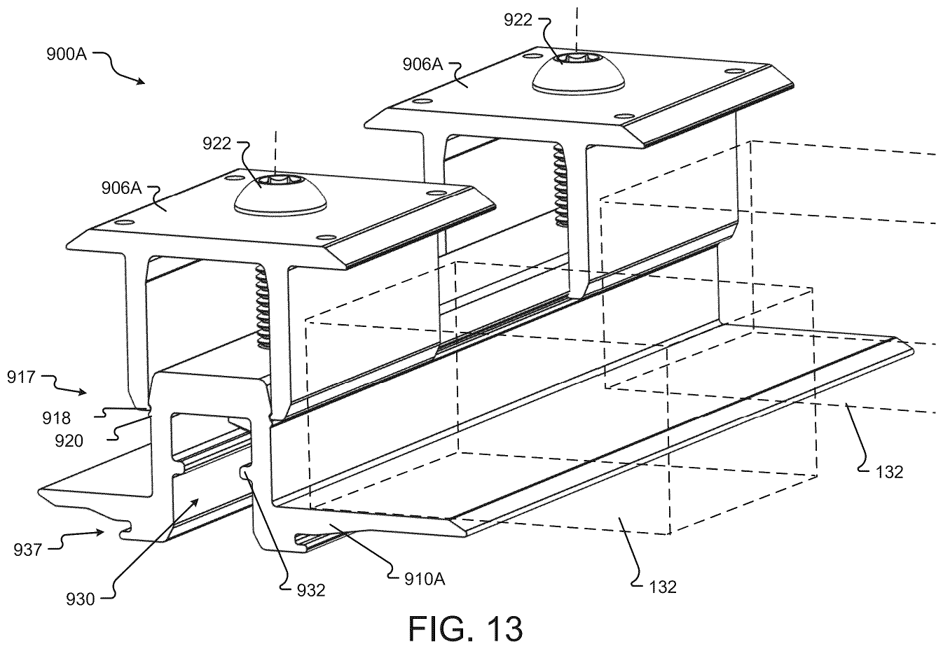

For example, as illustrated in FIG. 13, a variation of the mounting system 900, labelled mounting system 900A, includes a variation of the mount 910, labelled mount 910A, in accordance with one or more embodiments of the present disclosure.

It should be understood that the mount 910A is interchangeable with the mount 910 as generally illustrated in FIGS. 9A-12C, including with respect to the engagement with the mounting device 102, the grab 906, and/or the riser 908. In addition, it should be understood that features of the mount 910 should be understood as being features of the mount 910A, unless otherwise noted, without departing from the scope of the present disclosure.

In this non-limiting example, the mount 910A is of a length that multiple grabs 906 may be installed on the same mount 910A. It is noted that the mount 910A may be positionable on one or more risers 908, where the one or more risers 908 may be couplable to one or more mounting devices 102. For instance, the mounting system 900 may include multiple grabs 906, one mount 910A, one riser 908 (e.g., that is of an extended length, similar to the mount 910A), and one or multiple mounting devices 102 to secure one or more PV modules 132 to a metal panel. Alternatively, the mounting system 900 may include multiple grabs 906, one mount 910A, multiple risers 908 (e.g., one per grab 906), and multiple mounting devices 102 (e.g., one per riser 908 and grab 906) to secure one or more PV modules 132 to a metal panel.

The extended length mounts 910A (and optional extended-length risers 908 and/or mounting devices 102) may be beneficial to provide increased support or rigidity between the PV modules 132 and the metal panel, while more evenly distributing contact forces between the PV modules 132 and metal panel. This may include better support or rigidity, and/or increased distribution of forces, for the same PV module 132 (or same two PV modules 132, with one extending in each direction from the mounting system 900). Alternatively or in addition, this may include better support or rigidity, and/or increased distribution of forces, for multiple PV modules 132 extending in the same direction from the mounting system 900. In general, the mounting system 900 with mount 910A may operate as a splice between adjacent PV modules 132 extending in the same direction from the mounting system 900. This includes being able to connect multiple PV modules 132 together optionally without need of a roof attachment, such as where the panel projection of the metal panel is not located in the mounting zone of the PV module 132.

In embodiments, the mounting system 900A illustrates only a single fastener 922 for each grab 906, with each grab 906 including only a single aperture (e.g., such that FIG. 13 illustrates a variation of the grab 906, labelled grab 906A), and the mount 910A including only a single respective aperture for each grab 906. However, it should be understood that the grab 906 with multiple apertures may be assembled with the mount 910A, and that the mount 910A may include multiple respective corresponding apertures, for multiple fasteners (e.g., apertures 922 and 912) without departing from the scope of the present disclosure.

It is noted that FIG. 13 illustrates the interlocking assemblies 917 (e.g., with groove 918 on the mount 910A and engaged protrusion 920 on the grabs 906A) in the first pre-installation configuration for the mounting system 900, as compared to the post-installation configuration illustrated in FIGS. 9A-9D for the mounting system 900A. Although a PV module 132 is shown with the pre-installation configuration, the grabs 906A do not yet secure (and optionally engage) the PV module 132 with the mount 910A. It should be understood that the pre-installation configuration of the interlocking assemblies 917 for the mounting system 900 would be similar to the pre-installation configuration of the interlocking assemblies 917 for the mounting system 900A, without departing from the scope of the present disclosure. Similarly, it should be understood that the post-installation configuration of the interlocking assemblies 917 for the mounting system 900A would be similar to the post-installation configuration of the interlocking assemblies 917 for the mounting system 900, without departing from the scope of the present disclosure.

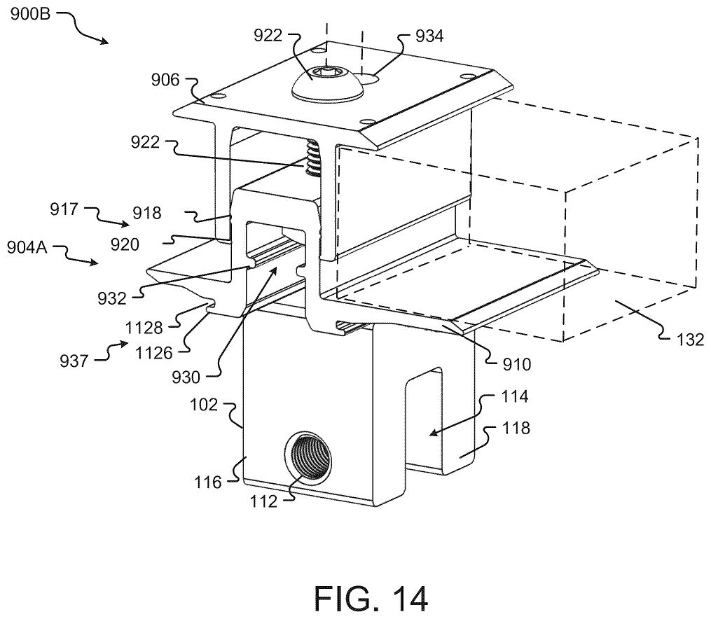

By way of another example, as illustrated in FIG. 14, a variation of the mounting system 900, labelled mounting system 900B, does not include the riser 908 in accordance with one or more embodiments of the present disclosure. In mounting system 900B, the mount 910 is positionable directly on the mounting device 102, such that only the mount 910 forms a variation of the mounting assembly 104, labelled mounting assembly 104A.

In this non-limiting example, the fastener 922 couples the grab 906 and the mount 910. Where the fastener 922 requires the second fastener 928 to couple the grab 906 and the mount 910, the mount 910 includes the protrusions 932 to support the second fastener 928. Although not shown, the fastener 912 couples the mount 910 to the mounting device 102, which is accessible via the aperture 934 in the grab 906. With the removal of the riser 908, the interlocking assemblies 937 are not utilized within the mounting system 900B.

The removal of the riser 908 in the mounting system 900B (or, conversely, the addition of the riser 908 in the mounting system 900) is beneficial to adjust the height of the PV modules 132 secured to the metal panel by the respective mounting systems 900, 900b a desired or pre-determined height from the metal panel. In addition, select PV modules 132 may require an amount of airgap between the metal panel and the glass of the PV module 132 that is not afforded by the mounting device 102 and the mount 110 alone. Here, insertion of the riser 908 into the mounting assembly 904 may address the gap or spacing requirement, allowing PV modules 132 installed on the metal panel with the mounting system 900 to remain compliant with PV module 132 manufacturer air flow requirements. Generally, the riser 908 can be included in the mounting assembly 904 with the mount 910 to increase the gap or spacing between a mounted PV module 132 and the metal panel.

It is noted that FIG. 14 illustrates the interlocking assemblies 917 (e.g., with groove 918 on the mount 910 and disengaged protrusion 920 on the grab 906) in the second post-installation configuration for the mounting system 900 with installed PV module 132, for purposes of the present disclosure. However, it should be understood that the pre-installation configuration of the interlocking assemblies 917 for the mounting system 900B would be similar to the pre-installation configuration of the interlocking assemblies 917 for the mounting system 900A, without departing from the scope of the present disclosure. Similarly, it should be understood that the post-installation configuration of the interlocking assemblies 917 for the mounting system 900A would be similar to the post-installation configuration of the interlocking assemblies 917 for the mounting system 900B, without departing from the scope of the present disclosure.

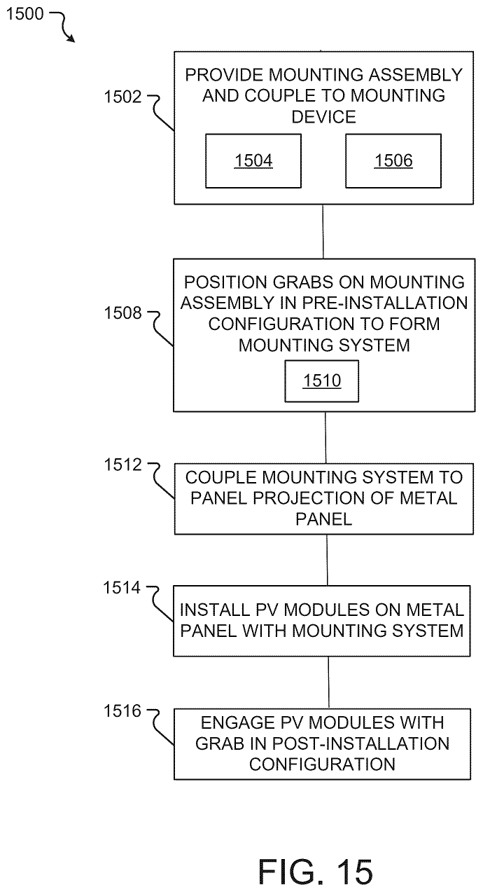

FIG. 15 is a flow diagram of a method or process 1500 illustrating the installation and operation of the mounting system 900, in accordance with one or more embodiments or the present disclosure. While a general order for the method or process is shown in FIG. 15, the method or process can include more or fewer operations or can arrange the order of the operations differently (including simultaneously, substantially simultaneously, or sequentially) than those shown in FIG. 15. It is noted that the method or process shall be explained with reference to the components, devices, subassemblies, environments, etc. described in conjunction with FIGS. 9A-14. For example, it is noted that the embodiments as illustrated in FIGS. 9A-14 should be understood as reading on the embodiments described with respect to FIG. 15, and vice versa, without departing from the scope of the present disclosure.

In embodiments, a mounting assembly is provided and coupled 1502 to a mounting device. In some configurations, a mount is coupled to a riser to form 1504 the mounting assembly. For example, a mount 910/910A and a riser 908 may share interlocking features of interlocking assemblies 937, such that engaging the respective interlocking features of the interlocking assembly 937 form the mounting assembly 904 from the mount 910/910A and the riser 908. In other configurations, only the mount 910/910A is provided and the mounting system 900 does not include the riser 908, such that only the mount 910/910A forms the mounting assembly 904A.

For either of the mounting assembly 904/904A, a fastener is inserted 1506 through the mounting assembly into the mounting device. Where the mounting assembly 904 includes both the riser 908 and the mount 910/910A, a fastener 912 is inserted through an aperture 914 of the mount 910/910A and an aperture 916 of the riser 908 prior to engaging the mounting device 102. Where the mounting assembly 904A includes only the mount 910/910A, a fastener 912 is inserted through the aperture 914 of the mount 910/910A prior to engaging the mounting device 102.

In embodiments, grabs are positioned 1508 on the mounting assembly in a pre-installation configuration to form a mounting system. In some configurations, a single grab 906/906A is installed on a single mount 910/910A. In other configurations, multiple grabs 906/906A are installed on a single mount 910/910A.

One or more grabs 906/906A may share interlocking features of interlocking assemblies 917 with the mount 910/910A of the mounting assembly 904/904A. Engaging the respective interlocking features of the interlocking assembly 917 positions the grabs 906/906A on the mount 910/910A of the mounting assembly 904/904A in a pre-installation configuration, with the grabs 906/906A being held in the pre-installation position by the interlocking assemblies 917. Example pre-installation configurations are shown in FIG. 13.

When the grabs 906/906A are installed on the mount 910/910A of the mounting assembly 904/904A, a fastener is inserted 1510 through the grabs into the mounting assembly. A fastener 922 is inserted through an aperture 924 of the grab 904/904A and an aperture 926 of the mount 910/910A. Optionally, the fastener 922 engages a second fastener 928.

In this regard, the mounting system 900/900A may be fully assembled prior to installation on a metal panel. It is noted that pre-assembly may save time for an installer, with the mounting system 900/900A coming partially or fully pre-assembled from the manufacturer. Alternatively, or in addition, pre-assembly may save time and/or be safer for an installer, with the installer completing pre-assembly on a ground surface instead of while on a roof or other structure with a panel projection. It is noted that the pre-installation configuration allows for the mounting system 900/900A to be pre-set, reducing the difficulty of installation (e.g., including, optionally, reducing the number of installers required during installation).

In embodiments, the mounting system is coupled 1512 to a panel projection on a metal panel. For example, the mounting device 102 may be selected for a particular panel projection, such that the mounting system 900/900A is specific to a particular panel projection. By way of another example, the mounting device 102 (and thus the mounting system 900/900A) may be agnostic to and installable on any of a number of panel projections.

In embodiments, one or more PV modules are installed 1514 on the metal panel with the mounting system. For example, a first PV module 132 may be installed on a first PV platform 1114 of the mount 910/mount 910A. By way of another example, a second PV module 132 may be installed on a second PV platform 1120 of the mount 910/mount 910A.

In embodiments, such as where the grab 906/906A is not pre-set at a height from the mount 910/910A to secure the PV modules, the PV modules are engaged 1516 with the grab in a post-installation configuration. For example, the first PV module 132 may be secured by a first arm 1210 of the grab 906/grab 906A and the first PV platform 1114 of the mount 910/mount 910A, by turning the fastener 922 to cause the interlocking assemblies 917 to disengage and allow for contact between the first arm 1210 and the first PV module 132. Optionally, engagement features 1212 of the first arm 1210 (and/or grounding inserts 400, if installed on the first PV platform 1114) may engage with the first PV module 132. By way of another example, the second PV module 132 may be secured by a second arm 1214 of the grab 906/grab 906A and the second PV platform 1120 of the mount 910/mount 910A, by turning the fastener 922 to cause the interlocking assemblies 917 to disengage and allow for contact between the second arm 1214 and the second PV module 132. Optionally, engagement features 1216 of the second arm 1214 (and/or grounding inserts 400, if installed on the second PV platform 1120) may engage with the second PV module 132.

It is noted that the installation of the PV modules 132 may be performed by the same individual or different individuals at the same time or different times, such as where a first installer places mounting system 900/900A on the metal panel and a second installer later places the PV modules 132 on the mounting system 900/900A.

In this regard, advantages of the present disclosure are directed to a mounting system for a metal panel. The mounting system is less complex and less restrictive in terms of methods of installation, reducing installation time and cost. The mounting system includes components that are economical to produce, reducing manufacturing material and time. The mounting system includes components that provide increased performance as compared to other known mounting systems.

Advantages of the present disclosure include, but are not limited to, a mounting system with a mounting device, a mounting assembly, and a grab that is couplable to a panel projection of the metal panel. The mounting assembly includes a separate riser and mount, or an integrated mount, between the mounting device and the grab. A PV module is insertable between the separate mount or integrated mount of the mounting assembly and the grab, which secures the PV module to the mounting system (and thus to the panel projection on the metal panel via the mounting device).

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

What is claimed is:

1. A mounting system for coupling a photovoltaic (PV) module to a metal panel of a building, the mounting system comprising:
a mounting device operable to couple to a panel projection of the metal panel;
a mounting assembly positionable on the mounting device, the mounting assembly including a PV platform;
a grab positionable on the mounting assembly, the grab including a body and an arm;
a first fastener insertable through at least one aperture in the mounting assembly and into an aperture in the mounting device to couple the mounting assembly to the mounting device, wherein the first fastener is accessible via a first aperture within the body of the grab; and
a second fastener insertable through a second aperture within the body of the grab and at least a second aperture in the mounting assembly to couple the grab to the mounting assembly, wherein a longitudinal axis through the second fastener is offset from a longitudinal axis through the first fastener,
wherein the arm of the grab and the PV platform of the mounting assembly together define a space for a PV module, and wherein the PV module is securable within the defined space when inserted between the arm and the PV platform.

2. The mounting system of claim 1, wherein the mounting assembly comprises:
a mount including a body with an aperture of the at least one aperture of the mounting assembly and a leg extending from the body, wherein the PV platform extends from the leg,
wherein the grab is positionable on the leg of the mount, and
wherein the first fastener is insertable through the aperture of the body of the mount and into the aperture of the mounting device.

3. The mounting system of claim 2, wherein the grab couples to the mount via at least one interlocking assembly, wherein the grab is positionable in a first configuration and a second configuration on the mount via the at least one interlocking assembly.

4. The mounting system of claim 3, wherein the at least one interlocking assembly includes a recess on the mount and a protrusion on the grab,
wherein when the grab is in the first configuration the protrusion is engaged with the recess and the arm of the grab is spaced a first distance from the PV platform of the mount, and
wherein when the grab is in the second configuration the protrusion is disengaged from the recess and the arm of the grab is spaced a second distance from the PV platform of the mount.

5. The mounting system of claim 4, wherein when the grab is in the second configuration the second distance is less than the first distance, and the arm makes contact with the PV module.

6. The mounting system of claim 4, wherein the grab transitions from the first configuration to the second configuration via rotation of the second fastener.

7. The mounting system of claim 2, wherein the mount is positionable on the mounting device.

8. The mounting system of claim 2, wherein the mounting assembly further comprises:
a riser positionable on the mounting device, the riser including a base with a second aperture of the at least one aperture of the mounting assembly and a sidewall extending from the base,
wherein the mount couples to the riser via at least one interlocking assembly, and
wherein the first fastener is insertable through the aperture of the body of the mount, the second aperture of the base of the riser, and the aperture of the mounting device.

9. The mounting system of claim 8, wherein the at least one interlocking assembly includes one or more of a notch and a protrusion of the riser that are configured to receive one or more of a respective protrusion and a respective notch of the mount.

10. The mounting system of claim 2, wherein the mounting system is configured such that the first fastener is insertable into the aperture of the body of the mount and the aperture of the mounting device prior to the grab being coupled to the mount.

11. The mounting system of claim 2, wherein the mount defines a cavity into which at least one protrusion extends, wherein the at least one protrusion supports a third fastener able to engage with the second fastener after insertion of the second fastener through the second aperture of the grab and through an aperture of the body of the mount of the at least a second aperture of the mounting assembly.

12. The mounting system of claim 1, the mounting assembly including a second PV platform and the grab including a second arm,
wherein the second arm of the grab and the second PV platform of the mounting assembly together define a second space for a second PV module, and
wherein the second PV module is securable within the defined space when inserted between the second arm and the second PV platform.

13. A method for coupling a photovoltaic (PV) module to a metal panel of a building, the method comprising:
providing a mounting assembly and coupling the mounting assembly to a mounting device operable to couple to a panel projection of the metal panel, wherein the mounting assembly includes a PV platform, and wherein a first fastener is insertable through at least one aperture in the mounting assembly and into an aperture in the mounting device to couple the mounting assembly to the mounting device; and
positioning a grab on the mounting assembly to form a mounting system, wherein the grab includes a body and an arm, wherein the first fastener is accessible via a first aperture within the body of the grab, wherein a second fastener is insertable through a second aperture within the body of the grab and at least a second aperture in the mounting assembly to couple the grab to the mounting assembly, and wherein a longitudinal axis through the second fastener is offset from a longitudinal axis through the first fastener.

14. The method of claim 13, wherein the providing a mounting assembly and coupling the mounting assembly comprises:
providing a mount including a body with an aperture of the at least one aperture of the mounting assembly and a leg extending from the body, wherein the PV platform extends from the leg,
wherein the grab is positionable on the mount, and
wherein the first fastener is insertable through the aperture of the body of the mount and into the aperture of the mounting device.

15. The method of claim 14, wherein the grab couples to the mount via at least one interlocking assembly, wherein the grab is positionable in a first configuration and a second configuration on the mount via the at least one interlocking assembly.

16. The method of claim 15, wherein the at least one interlocking assembly includes a recess on the mount and a protrusion on the grab,
wherein when the grab is in the first configuration the protrusion is engaged with the recess and the arm of the grab is spaced a first distance from the PV platform of the mount, and
wherein when the grab is in the second configuration the protrusion is disengaged from the recess and the arm of the grab is spaced a second distance from the PV platform of the mount.

17. The method of claim 14, wherein the providing a mounting assembly and coupling the mounting assembly comprises:
providing a riser including a base with a second aperture of the at least one aperture of the mounting assembly and a sidewall extending from the base,
wherein the mount couples to the riser via at least one interlocking assembly, and
wherein the first fastener is insertable through the aperture of the body of the mount, the second aperture of the base of the riser, and the aperture of the mounting device.

18. The method of claim 17, wherein the at least one interlocking assembly includes one or more a notch and a protrusion of the riser that are configured to receive one or more of a respective protrusion and a respective notch of the mount.

19. The method of claim 17, further comprising:
coupling the mounting system to a panel projection of a metal panel;
installing a PV module in the mounting system, wherein the PV module is supported by the PV platform of the mounting assembly; and
engaging the PV module with the arm of the grab by rotating the second fastener.

20. A mounting system coupling at least one photovoltaic (PV) module for a metal panel of a building, the mounting system comprising:
a mounting device operable to couple to a panel projection of the metal panel;
a mounting assembly positionable on the mounting device, the mounting assembly including a PV platform that extends from a mount including a groove;
a first grab positionable on the mount, the first grab including a first body and a first arm, wherein the first grab couples to the mount via at least a first interlocking assembly including a first protrusion on a first leg extending from the first body which is able to engage with the groove of the mounting assembly, wherein the first grab is positionable in a first configuration and a second configuration on the mount via the at least a first interlocking assembly;
a first fastener insertable through an aperture in the first grab and a first aperture in the mount to couple the first grab to the mount;
a second grab positionable on the mount, the second grab including a second body and a second arm, wherein the second grab couples to the mount via at least a second interlocking assembly including a second protrusion on a second leg extending from the second body which is able to engage with the groove of the mounting assembly, wherein the second grab is positionable in a third configuration and a fourth configuration on the mount via the at least a second interlocking assembly; and
a second fastener insertable through an aperture in the second grab and a second aperture in the mount to couple the second grab to the mount,
wherein the first arm of the first grab and the PV platform of the mounting assembly together define a first space for a first PV module, wherein the first PV module is securable within the defined first space when inserted between the first arm and the PV platform,
wherein the second arm of the second grab and the PV platform of the mounting assembly together define a second space for a second PV module, and wherein the second PV module is securable within the defined second space when inserted between the second arm and the PV platform.
